(19) United States
(12) Patent Application Publication
(10) Pub. No.: US 2015/0072144 A1
(43) Pub. Date: Mar. 12, 2015

(54) LED CURING OF RADIATION CURABLE OPTICAL FIBER COATING COMPOSITIONS

(71) Applicant: DSM IP Assets B.V., Heerlen (NL)

(72) Inventors: Timothy BISHOP, Algonquin, IL (US); Keqi GAN, Geneva, IL (US)

(21) Appl. No.: 14/539,862

(22) Filed: Nov. 12, 2014

Related U.S. Application Data
(62) Division of application No. 13/388,718, filed on Apr. 16, 2012.
(60) Provisional application No. 61/287,567, filed on Dec. 17, 2009.

(51) Int. Cl. G02B 6/02; C03C 25/62; C03B 37/03; C03C 25/10

(52) U.S. Cl. CPC G02B 6/02395; C03C 25/106; C03C 25/6226; C03C 25/622; C03C 25/6213; C03B 37/032
USPC 428/392; 427/513; 65/432

(57) ABSTRACT

A radiation curable coating composition for an optical fiber comprising: at least one urethane (meth) acrylate oligomer, at least one reactive diluent monomer and at least one photo initiator is described and claimed. The composition is capable of undergoing photopolymerization when coated on an optical fiber and when irradiated by a light emitting diode (LED) light, having a wavelength from about 100 nm to about 900 nm, to provide a cured coating on the optical fiber, with the cured coating having a top surface, and the cured coating having a Percent Reacted Acrylate Unsaturation (% RAU) at the top surface of about 60% or greater. Also described and claimed are the process to coat an optical fiber with the LED curable coating for optical fiber and a coated optical fiber where the coating has been cured by application of LED light.

### CROSS-REFERENCE TO RELATED PATENT APPLICATION

This patent application claims priority to U.S. Provisional Patent Application No. 61/287,567 filed on Dec. 17, 2009, which is incorporated by reference in its entirety.

### FIELD OF THE INVENTION

The present invention relates to radiation curable coatings for optical fiber and methods of formulating these compositions.

### BACKGROUND OF THE INVENTION

The use of ultraviolet mercury are lamps to emit ultraviolet light suitable to cure radiation curable coatings applied to optical fiber is well known. Ultraviolet arc lamps emit light by using an electric arc to excite mercury that resides inside an inert gas (e.g., Argon) environment to generate ultraviolet light which effectuates curing. Alternatively, microwave energy can also be used to excite mercury lamps in an inert gas medium to generate the ultraviolet light. Throughout this patent application, arc excited and microwave excited mercury lamp, plus various additives (ferrous metal, Gallium, etc.) modified forms of these mercury lamps are identified as mercury lamps.

However, the use of ultraviolet mercury lamps as a radiation source suffers from several disadvantages including environmental concerns from mercury and the generation of ozone as a by-product. Further, mercury lamps typically have lower energy conversion ration, require warm-up time, generate heat during operation, and consume a large amount of energy when compared with LED. {In the production of coated optical fiber, the heat generated by the UV mercury lamps can negatively impact the liquid coating in that if the coating is not formulated to avoid the presence of volatiles, those volatiles may be excited and deposit upon the quartz tube surface, blocking the UV rays from irradiating the liquid coating on the glass fiber which inhibits the curing of the liquid coating to a solid.} Accordingly, alternative radiation sources are being investigated.

Light emitting diodes (LEDs) are semiconductor devices which use the phenomenon of electroluminescence to generate light. LEDs consist of a semiconducting material doped with impurities to create a p-n junction capable of emitting light as positive holes join with negative electrons when voltage is applied. The wavelength of emitted light is determined by the materials used in the active region of the semiconductor. Typical materials used in semiconductors of LEDs include, for example, elements from Groups 13 (III) and 15 (V) of the periodic table. These semiconductors are referred to as III-V semiconductors and include, for example, GaAs, GaP, GaAsP, AlGaAs, InGaAsP, AlGaINP, and InGaN semiconductors. Other examples of semiconductors used in LEDs include compounds from Group 14 (IV-IV semiconductor) and Group 12-16 (II-VI). The choice of materials is based on multiple factors including desired wavelength of emission, performance parameters, and cost.

Early LEDs used gallium arsenide (GaAs) to emit infrared (IR) radiation and low intensity red light. Advances in materials science have led to the development of LEDs capable of emitting light with higher intensity and shorter wavelengths, including other colors of visible light and UV light. It is possible to create LEDs that emit light anywhere from a low of about 100 nm to a high of about 900 nm. Currently, known LED UV light sources emit light at wavelengths between about 300 and about 475 nm, with 365 nm, 390 nm and 395 nm being common peak spectral outputs. See textbook, “Light-Emitting Diodes” by E. Fred Schubert, 2nd Edition, © E. Fred Schubert 2006, published by Cambridge University Press.

LED lamps offer advantages over mercury lamps in curing applications. For example, LED lamps do not use mercury to generate UV light and are typically less bulky than mercury UV arc lamps. In addition, LED lamps are instant on/off sources requiring no warm-up time, which contributes to LED lamps' low energy consumption. LED lamps also generate much less heat, with higher energy conversion efficiency, have longer lamp lifetimes, and are essentially monochromatic emitting a desired wavelength of light which is governed by the choice of semiconductor materials employed in the LED.

Several manufactures offer LED lamps for commercial curing applications. For example, Phoseon Technology, Summit UV Honle UV America, Inc., IST Metz GmbH, Jenton International Ltd., Luminos Solutions Ltd., Solid UV Inc., Seoul Optodevice Co., Ltd, Spectronics Corporation, Luminus Devices Inc., and Clearstone Technologies, are some of the manufacturers currently offering LED lamps for curing ink-jet printing composition, PVC floor coating compositions, metal coating compositions, plastic coating composition, and adhesive compositions.

In the known UV curing applications for dental work, there are existing LED curing devices available. An example of a known curing device for dental work is the Elipar™ FreeLight 2 LED curing light from 3M ESPE. This device emits light in the visible region with a peak irradiance at 460 nm.

LED equipment is also being tested in the ink-jet printing market: IST Metz has publicly presented a demonstration of its entrance into UV curing via LED. This company says it has been working on LED based UV curing technology over the past several years, primarily for the inkjet market, where this technology is currently used.

Current radiation curable optical fiber coating compositions are not suitable four curing by LED lamps because heretofore these compositions have been formulated to be cured by mercury lights which produce a different spectral output, namely a spectral output over several wavelengths. Though currently available “conventionally curing” UV curable coatings for optical fiber may actually begin to cure when exposed to light from an LED light source, the cure speed is so slow the coating would not cure at the currently industry standard “fast” line speeds of upwards of 1500 meters/minute. Therefore, it is not practical to use currently available LED lamps to cure currently available radiation curable coatings for optical fiber.

U.S. Pat. No. 7,399,982 (“the '982 patent”) states that it provides a method of UV curing coatings or printings on various objects, particularly objects such as wired, cables, tubes, tubing, hoses, pipes, CDs, DVDs, golf balls, golf tees, eye glasses, contact lenses, string instruments, decorative labels, peelable labels, peelable stamps, doors, and countertops. While the '982 patent mentions optical fibers in the background or in the context of the mechanical configuration of the coating apparatus, it does not disclose a coating composition, or ingredients thereof, that is coated and cured successfully on an optical fiber using UV-LED. Thus, there is no enabling disclosure of LED curable coatings for optical fiber in the '982 patent.

U.S. Patent Application Publication No. 2007/0112090 (“the '090 publication”) states that it provides an LED radiation curable rubber composition comprising an organopolysiloxane having a plurality of (meth)acryloyl groups, a radiation sensitizer, and an optional titanium-containing organic compound. the '090 publication states the composition is useful as a protective coating agent or a sealing agent for the electrodes of liquid crystal displays, organic electronic displays, flat panel displays, and for other electrical and electronic components. The '090 publication states, in the Description of the prior art, that a prior art patent's (U.S. Pat. No. 4,733,942) UV curable composition comprising organopolysiloxane having a plurality of vinyl functional groups such as acryloyloxy groups or (meth)acryloyloxy groups is unable to meet the demand or requirement that the composition should be curable by UV-LED, due to slow curing rates. Further, the '090 publication states that another prior art patent (U.S. Pat. No. 6,069,186) proposed a radiation-curable silicone rubber composition comprising an organopolysiloxane, which contained one radiation-sensitive organic group containing a plurality of (meth)acryloylox groups at each of the molecular chain terminals, a photosensitizer, and an organosilicon compound that contains no alkoxy group. According to the '090 publication, the composition of the '186 patent did not satisfy the above demand. Thus, there is no enabling disclosure of LED curable coatings for optical fiber in the '090 publication or in any of the documents (the '942 patent and the '186 patent) cited therein.

U.S. Patent Application Publication No. 2003/0026919 (“the '919 publication”) states that it discloses an optical fiber resin coating apparatus having an ultraviolet flash lamp used for coating an optical fiber by an ultraviolet curing resin, a lamp lighting circuit for making the ultraviolet flash lamp emit light, and a control circuit for controlling this lamp lighting circuit. The '919 publication states that, as the ultraviolet light source, at least one ultraviolet laser diode or ultraviolet light emitting diode may be used instead of an ultraviolet flash lamp. While the '919 publication mentions that epoxy-based acrylate resin as an example of an ultraviolet curing resin, it does not provide details on the resin or on a composition comprising such resin. The '919 publication does not disclose an optical fiber coating composition comprising at least one acrylate oligomer, at least one photoinitiator, and at least one reactive diluent monomer that is coated and cured successfully on an optical fiber using LED light. Thus, there is no enabling disclosure of a composition of a LED radiation curable coating for optical fiber in the '919 publication.

PCT Published Patent Application WO 2005/103121, entitled “Method for photocuring of Resin Compositions”, assigned to DSM IP Assets B. V., describes and claims Methods for Light Emitting Diode (LED) curing of a curable resin composition containing a photoinitiating system, characterized in that the highest wavelength at which absorption maximum of the photoinitiating system occurs (λMax PIS) is at least 20 nm below, and at most 100 nm below the wavelength at which the emission maximum of the LED occurs (λLED). The invention in this PCT patent application relates to the use of LED curing in structural applications, in particular in applications for the lining or relining of objects, and to objects containing a cured resin composition obtained by LED curing. This invention provides a simple, environmentally safe and readily controllable method for (re)lining pipes, tanks and vessels, especially for such pipes and equipment having a large diameter, in particular more than 15 cm. Thus, there is no enabling disclosure of a composition of a LED radiation curable coating for optical fiber in the WO 2015/103121 publication.

U.S. Published Patent Application 20100242299, published on Sep. 30, 2010 described and claims a rotatably indexable and stackable apparatus and method for UV curing an elongated member or at least one UV-curable ink, coating or adhesive applied thereon is further disclosed, comprising at least one UV-LED mounted on one side of the elongated member, and an elliptically-shaped reflector positioned on the other side of the elongated member opposite the at least one UV-LED.

In the same patent family as U.S. Published Patent Application 20100242299, Issued U.S. Pat. 7,175,712, issued on Feb. 13, 2007, describes and claims a UV curing apparatus and method is provided for enhancing the distribution and application of UV light to UV photo initiators in a UV curable ink, coating or adhesive. The UV curing apparatus and method comprises UV LED assemblies in a first row with the UV LED assemblies spaced from adjacent UV LED assemblies. At least one second row of a plurality of UV LED assemblies are provided next to the first row but with the UV LED assemblies of the second row positioned adjacent the spaces between adjacent UV LED assemblies in the first row thereby to stagger the second row of UV LED assemblies from the UV LED assemblies in the first row. Desirably, the rows of staggered UV LED assemblies are mounted on a panel. UV curable products, articles or other objects containing UV photo initiators that are in or on a web can be conveyed or otherwise moved past the rows of UV LED assemblies for effective UV curing. This arrangement facilitates more uniformly application of UV light on the UV curable ink, coating and/or adhesives in the UV curable products, articles or other objects. The apparatus can include one or more of the following: rollers for moving the web, mechanisms for causing the panel to move in an orbital or reciprocal path, and an injection tube for injecting a non-oxygen gas in the area of UV tight curing.

The foregoing shows that there is an unmet need to provide radiation curable optical fiber coating compositions which are suitable for curing by LED light, to provide processes for coating optical fiber with such coating compositions, and to provide coated optical fiber comprising coatings prepared from such coating compositions.

### SUMMARY OF THE INVENTION

The first aspect of the instant claimed invention is a radiation curable coating composition for an optical fiber, wherein the composition is capable of undergoing photopolymerization when coated on an optical fiber and when irradiated by a light emitting diode (LED) light, having a wavelength from 100 nm to 900 nm, to provide a cured coating on the optical fiber, said cured coating having a top surface, said cured coating having a Percent Reacted Acrylate Unsaturation (% RAU) at the top surface of 60% or greater.

The second aspect of the instant claimed invention is a radiation curable coating composition of the first aspect of the instant claimed invention, wherein the light emitting diode (LED) light has a wavelength of:
from 100 nm to 300 nm;
from 300 nm to 475 nm; or
from 475 nm to 900 nm.

The third aspect of the instant claimed invention is a radiation curable coating composition according to the first aspect of the instant claimed invention, said composition comprising:
at least one urethane (meth)acrylate oligomer;
(b) at least one reactive diluent monomer; and
(c) at least one photoinitiator.

The fourth aspect of the instant claimed invention is a radiation curable coating composition of the third aspect of the instant claimed invention, wherein the photoinitiator is a Type I photoinitiator.

The fifth aspect of the instant claimed invention is a radiation curable coating composition of the third aspect of the instant claimed invention, wherein the photoinitiator is a Type II photoinitiator and the composition includes a hydrogen donor.

The sixth aspect of the instant claimed invention is a radiation curable coating composition of any one of the first through fifth aspect of the instant claimed invention, wherein the coating composition is selected from the group consisting of a primary coating composition, a secondary coating composition, an ink coating composition, a buffer coating composition, a matrix coating composition and an Upjacketing coating composition.

The seventh aspect of the instant claimed invention is a radiation curable coating composition of any one of the first through sixth aspects of the instant claimed invention, in which at least 15% of the ingredients in the coating are bio-based, rather than petroleum based, preferably at least 20% of the ingredients, more preferably at least 25% of the ingredients.

The eighth aspect of the instant claimed invention is a process for coating an optical fiber comprising:
(a) providing a glass optical fiber,
(b) coating said glass optical fiber with at least one radiation curable coating composition for an optical fiber, preferably a radiation curable coating composition according to any one of the first through seventh aspects of the instant claimed invention, wherein said at least one radiation curable coating composition comprises:
   (i) at least one urethane (meth) acrylate oligomer;
   (ii) at least one reactive diluent monomer; and
   (iii) at least one photoinitiator;
   to obtain a coated glass optical fiber with an uncured coating, and
(c) curing said uncured coating on said coated glass optical fiber by irradiating said uncured coating with a light emitting diode (LED) light, having a wavelength from 100 nm to 900 nm, to obtain a cured coating having a top surface, said cured coating having a % Reacted Acrylate Unsaturation (% RAU) at the top surface of about 60% or greater.

The ninth aspect of the instant claimed invention is a process according to the eighth aspect of the instant claimed invention, wherein said glass optical fiber is provided by operating a glass draw tower to produce the glass optical fiber.

The tenth aspect of the instant claimed invention is a process of the ninth aspect of the instant claimed invention, wherein the glass draw tower is operated at a line speed of the optical fiber from 100 m/min to 2500 m/min, such as from 1000 m/min to 2400 m/min, or from 1200 m/min to 2300 m/min.

The eleventh aspect of the instant claimed invention is a process of any one of the eighth through tenth aspects of the instant claimed invention, wherein the light emitting diode (LED) light has a wavelength of
from 100 nm to 300 nm;
from 300 nm to 475 nm; or
from 475 nm to 900 nm.

The twelfth aspect of the instant claimed invention is a process of any one of the eighth through eleventh aspects of the instant claimed invention, wherein the photoinitiator is a Type I photoinitiator.

The thirteenth aspect of the instant claimed invention is a process of any one of the eighth through eleventh aspects of the instant claimed invention, wherein the photoinitiator is a Type II photoinitiator and the composition includes a hydrogen donor.

The fourteenth aspect of the instant claimed invention is a coated optical fiber which is obtainable by the process of any one of the eighth through thirteenth aspect of the instant claimed invention.

The fifteenth aspect of the instant claimed invention is a coated optical fiber of the fourteenth aspect of the instant claimed invention, wherein the coating composition is selected from the group consisting of a primary coating composition, a secondary coating composition, an ink coating composition, a buffer coating composition, a matrix coating composition and an Upjacketing coating composition.

The sixteenth aspect of the instant claimed invention is a radiation curable coating composition for an optical fiber comprising:
(a) at least one urethane (meth) acrylate oligomer;
(b) at least one reactive diluent monomer; and
(c) at least one photoinitiator;
   wherein the composition is capable of undergoing photopolymerization when coated on an optical fiber and when irradiated by a light emitting diode (LED) light, having a wavelength from about 100 nm to about 900 nm, to provide a cured coating on the optical fiber, said cured coating having a top surface, said cured coating having a Percent Reacted Acrylate Unsaturation (% RAU) at the top surface of about 60% or greater.

The seventeenth aspect of the instant claimed invention is a coated optical fiber comprising an optical fiber and at least one coating, wherein said at least one coating is produced by coating the optical fiber with at least one radiation curable coating composition for an optical fiber comprising:
(a) at least one urethane (meth) acrylate oligomer;
(b) at least one reactive diluent monomer; and
(c) at least one photoinitiator;
   to obtain an uncured coated optical fiber, and curing said uncured coated optical fiber by irradiating with a light emitting diode (LED) light having wavelength from about 100 nm to about 900 nm, to obtain a cured coating having a top surface, said cured coating having a Percent Reacted Acrylate Unsaturation (% RAU) at the top surface of about 60% or greater.

The eighteenth aspect of the instant claimed invention is a process for coating an optical fiber comprising:
(a) operating a glass draw tower to produce a glass optical fiber;
(b) coating said glass optical fiber with at least one radiation curable coating composition for an optical fiber, wherein said at least one radiation curable coating composition comprises:
   (i) at least one urethane (meth) acrylate oligomer;
   (ii) at least one reactive diluent monomer; and
   (iii) at least one photoinitiator;
      to obtain a coated glass optical fiber with an uncured coating, and
(c) curing said uncured coating on said coated glass optical fiber by irradiating said uncured coating with a light emitting diode (LED) light, having a wavelength from about 100 nm to about 900 nm, to obtain a cured coating having a top surface, said cured coating having a % Reacted Acrylate Unsaturation (% RAU) at the top surface of about 60% or greater.

The nineteenth aspect of the instant claimed invention is a radiation curable optical fiber coating composition of the sixteenth aspect of the instant claimed invention, wherein the light emitting diode (LED) light has a wavelength from about 100 nm to about 300 nm.

The twentieth aspect of the instant claimed invention is a radiation curable optical fiber coating composition of the sixteenth aspect of the instant claimed invention, wherein the light emitting diode (LED) light has a wavelength from about 200 nm to about 475 nm.

The twenty-first aspect of the instant claimed invention is a radiation curable optical fiber coating composition of the sixteenth aspect of the instant claimed invention, wherein the light emitting diode (LED) light has a wavelength from about 475 nm to about 900 nm.

The twenty-second aspect of the instant claimed invention is a radiation curable optical fiber coating composition of the sixteenth aspect of the instant claimed invention, wherein the photoinitiator is a Type I photoinitiator.

The twenty-third aspect of the instant claimed invention is a radiation curable optical fiber coating composition of the sixteenth aspect of the instant claimed invention, wherein the photoinitiator is a Type II photoinitiator and the composition includes a hydrogen donor.

The twenty-fourth aspect of the instant claimed invention is a radiation curable optical fiber coating composition of the sixteenth aspect of the instant claimed invention, wherein the coating composition is selected from the group consisting of a primary coating composition, a secondary coating composition, an ink coating composition, a buffer coating composition, a matrix coating composition and an Upjacketing coating composition.

The twenty-fifth aspect of the instant claimed invention is a radiation curable optical fiber coating composition of the sixteenth aspect of the instant claimed invention, in which at least about 15% of the ingredients in the coating are bio-based, rather than petroleum based.

The twenty-sixth aspect of the instant claimed invention is a radiation curable optical fiber coating composition of the twenty-fifth aspect of the instant claimed invention, in which at least about 20% of the ingredients in the composition are bio-based, rather than petroleum based.

The twenty-seventh aspect of the instant claimed invention is a radiation curable optical fiber coating composition of Claim 11, in which at least about 25% of the ingredients in the composition are bio-based, rather than petroleum based.

The twenty-eighth aspect of the instant claimed invention is a coated optical fiber of the seventeenth aspect of the instant claimed invention, wherein the light emitting diode (LED) light has a wavelength from about 100 nm to about 300 nm.

The twenty-ninth aspect of the instant claimed invention is a coated optical fiber of the seventeenth aspect of the instant claimed invention, wherein the light emitting diode (LED) light has a wavelength from about 300 nm to about 474 nm.

The thirtieth aspect of the instant claimed invention is a coated optical fiber of the seventeenth aspect of the instant claimed invention, wherein the light emitting diode (LED) light has a wavelength from about 475 nm to about 900 nm.

The thirty-first aspect of the instant claimed invention is a coated optical fiber of the seventeenth aspect of the instant claimed invention, wherein the photoinitiator is a Type I photoinitiator.

The thirty-second aspect of the instant claimed invention is a coated optical fiber of the seventeenth aspect of the instant claimed invention, wherein the photoinitiator is a Type II photoinitiator and the composition includes a hydrogen donor.

The thirty-third aspect of the instant claimed invention is a coated optical fiber of the seventeenth aspect of the instant claimed invention, wherein the coating composition is selected from the group consisting of a primary coating composition, a secondary coating composition, an ink coating composition, a buffer coating composition, a matrix coating composition, and an Upjacketing coating composition.

The thirty-fourth aspect of the instant claimed invention is a process of the eighteenth aspect of the instant claimed invention, wherein the line speed of the optical fiber is from about 100 m/min to about 2500 m/min.

The thirty-fifth aspect of the instant claimed invention is a process of the eighteenth aspect of the instant claimed invention, wherein the line speed of the optical fiber is from about 1000 m/min to about 2400 m/min.

The thirty-sixth aspect of the instant claimed invention is a process of the eighteenth aspect of the instant claimed invention, wherein the line speed of the optical fiber is from about 1,200 m/min to about 2300 m/min.

### DETAILED DESCRIPTION OF THE INVENTION

Throughout this patent application the following terms have the indicated meanings:

Optical Fiber: a glass fiber that carries light along its inner core. Light is kept in the core of the optical fiber by total internal reflection. This causes the fiber to act as a waveguide. The fiber consists of a core surrounded by a cladding layer, both of which are made of dielectric materials. To confine the optical signal in the core, the refractive index of the core must be greater than that of the cladding.

In a typical Single Mode (see definition below) optical fiber the outside diameter of the glass core is from about 8 to about microns. In a typical MultiMode (see definition below) optical fiber the outside diameter of the glass core is from about 50 to about 62.5 microns. In a typical optical fiber, the outside diameter of the Cladding, is about 125 microns. (see diagram, page 98, article entitled “Optical Fiber Coatings” by Steven R. Schmid and Anthony F. Toussaint, DSM Desotech, Elgin, Ill., Chapter 4 of Specialty Optical Fibers Handbook, edited by Alexis Mendez and T. F. Morse, ©2007 by Elsevier Inc.)

Optical Fibers which support many propagation paths or transverse modes are called MultiMode fibers (MMF), while those which can only support a single mode are called Single Mode fibers (SMF).

Primary Coating: is defined as the coating in contact with the cladding layer of an optical fiber. The primary coating is applied directly to the glass fiber and, when cured, forms a soft, classic, adherent, and compliant material which encapsulates the glass fiber. The primary coating serves as a buffer to cushion and protect the glass fiber core when the fiber is bent, cabled, spooled or otherwise handled. During the early years of development of glass optical fibers, the Primary Coating was sometimes referred to as the “inner primary coating”. The outside diameter of the Primary Coating, is from about 155 to about 205 microns.(see diagram, page 98, article entitled “Optical Fiber Coatings” by Steven R. Schmid and Anthony F. Toussaint, DSM Desotech, Elgin, Ill., Chapter 4 of Specialty Optical Fibers Handbook, edited by Alexis Mendez and T. F. Morse, ©2007 0 by Elsevier Inc.)

Secondary Coating: The secondary coating is applied over the primary coating and functions as a tough, protective outer layer that prevents damage to the glass fiber during processing and use. Certain characteristics are desirable for the secondary coating. Before curing, the secondary coating composition should have a suitable viscosity and be capable of curing quickly to enable processing of the optical fiber. After curing, the secondary coating should have the following characteristics: sufficient stiffness to protect the encapsulated, glass fiber yet enough flexibility for handling (i.e., modulus), low water absorption, low tackiness to enable handling of the optical fiber, chemical resistance, and sufficient adhesion to the primary coating.

To achieve the desired characteristics, conventional secondary coating compositions generally contain urethane-based oligomers in large concentration with monomers being introduced into the secondary coating composition as reactive diluents to lower the viscosity.

During the early years of development of glass optical fibers, the Secondary Coating was sometimes referred to as the “outer primary coating”. On a typical glass optical fiber the outside diameter of the Secondary Coating, is from about 240 to about 250 microns.

Ink or Ink Coating: is a radiation curable coating comprising pigments or dyes that cause the visible color of the coating to match one of several standard colors used in identifying optical fiber upon installation. An alternative to the use of an ink coating is to use a secondary coating that comprises pigments or dyes. A secondary coating that comprises pigments and/or dyes is also known as a “colored secondary” coating. On a typical glass optical fiber the typical thickness of an Ink or Ink Coating is from about 3 microns to about 10 microns.

Matrix or Matrix Coating: is used to fabricate a fiber optic ribbon. A fiber optic ribbon includes a plurality of substantially planar, substantially aligned optical fibers and a radiation curable matrix material encapsulating the plurality of optical fibers.

Loose Tube Configuration: as an alternative to being fabricated into a fiber optic ribbon, optical fibers may be field deployed in what is known as a “loose-tube” configuration. A Loose Tube Configuration is when many fibers are positioned in a hollow protective tube. The fibers may be surrounded by a protective e jelly in the Loose Tube or they may be surrounded by another type of protective material or the Loose Tube may only contain optical fibers.

Upjacketing or Upjacketing Coating: is a radiation curable coating that is applied over a colored secondary coating or over an ink coating layer in a relatively thick amount, which causes the outer diameter of the coated optical fiber to increase to a desired thickness of 400 micron, 500 micron, or 600 micron or 900 micron “tight buffered” fibers. These diameters are also used to described the finished upjacketed optical fibers as either 400 micron, 500 micron, or 600 micron or 900 micron “tight buffered”fibers.

Radiation Curable Primary Coatings and Secondary Coatings and Ink Coatings, and Matrix Coatings and Upjacketing Coatings for Optical Fiber are described and claimed in U.S. Pat. Nos. 4,472,019; 4,496,210; 4,514,037; 4,522,465; 4,624,994; 4,629,287; 4,682,851; 4,806,574; 4,806,694; 4,844,604; 4,849,462; 4,932,750;

U.S. Pat. Nos. 5,093,386; 5,219,896; 5,292,459; 5,336,503; 5,416,880; 5,456,984; 5,496,870; 5,502,145; 5,596,669; 5,664,041; 5,696,179; 5,712,035; 5,787,218; 5,804,311; 5,812,725; 5,837,750; 5,845,034; 5,859,087; 5,847,021; 5,891,930; 5,907,023; 5,913,004; 5,933,559; 5,958,584; 5,977,202; 5,986,018; 5,998,497;

U.S. Pat. Nos. 6,014,488; 6,023,547; 6,040,357; 6,052,503; 6,054,217; 6,063,888; 6,080,483; 6,085,010; 6,107,361; 6,110,593; 6,130,980; 6,136,880; 6,169,126; 6,180,741; 6,187,835; 6,191,187; 6,197,422; 6,214,899; 6,240,230; 6,246,824; 6,298,189; 6,301,415; 6,306,924; 6,309,747; 6,319,549; 6,323,255; 6,339,666; 6,359,025; 6,350,790; 6,362,249; 6,376,571; 6,391,936; 6,438,306; 6,472,450; 6,528,553; 6,534,557; 6,538,045; 6,563,996; 6,579,618; 6,599,956; 6,630,242; 6,638,616; 6,661,959; 6,714,712; 6,775,451; 6,797,740; 6,852,770; 6,858,657; 6,961,508;

U.S. Pat. Nos. 7,041,712; 7,067,564; 7,076,142; 7,122,247; 7,135,229; 7,155,100; 7,171,103; 7,214,431; 7,221,841; 7,226,958; 7,276,543; and 7,493,000, which are all incorporated by by reference, in their entirety.

UVA radiation is radiation with a wavelength between about 320 and about 400 nm.

UVB radiation is radiation with a wavelength between about 280 and about 320 nm.

UVC radiation is radiation with a wavelength between about 100 and about 280 nm.

As used herein, the term “renewable resource material” is defined as a starting material that is not derived from petroleum but as a starting material derived from a plant including the fruits, nuts and/or seeds of plants. These plant derived materials are environmentally friendly and biologically based materials. Thus, these starting materials are also frequently called “bio-based” materials or “natural oil” materials.

Further to the understood definition of “bio-based”, according to the FRSIA (Farm Security and Rural Investment Act), “biobased products” are products determined by the U.S. Secretary of Agriculture to be “commercial or industrial goods (other than food or feed) composed in whole or in significant part of biological products, forestry materials, or renewable domestic agricultural materials, including plant, animal or marine materials.

Biobased content may be determined by testing to ASTM Method D6866-10, STANDARD TEST METHODS FOR DETERMINING THE BIOBASED CONTENT OF SOLID, LIQUID, AND GASEOUS SAMPLES USING RADIOCARBON ANALYSIS. This method, similar to radiocarbon dating, compares how much of a decaying carbon isotope remains in a sample to how much would be in the same sample if it were made of entirely recently grown materials. The percentage is called the product's biobased content.

Persons of ordinary skill in the act of radiation curable coatings are aware of how to select ingredients and understand whether the ingredient is bio-based or petroleum based. What is different now is the sheer abundance of bio-based or petroleum based. What is different now is the sheer abundance of bio-based raw materials suitable for use in radiation curable coating. For example, bio-based raw materials can be found in polyols and other ingredients.

The sixteenth aspect of the instant claimed invention is a radiation curable coating composition for an optical fiber comprising:
(a) at least one urethane (meth) acrylate oligomer; and
(b) at least one reactive diluent monomer; and
(c) at least one photoinitiator;

wherein the composition is capable of undergoing photopolymerization when coated on an optical fiber and when irradiated by a light emitting diode (LED) light, having a wavelength from about 100 nm to about 900 nm, to provide a cured coating on the optical fiber, said cured coating having a top surface, said cured coating having a Percent Reacted Acrylate Unsaturation (% RAU) at the top surface of about 60% or greater.

Urethane (meth)acrylate oligomers are well known in the art of radiation curable coatings for optical fiber. See pages 103-104 of article entitled “Optical Fiber Coatings” by Steven R. Schmid and Anthony F. Toussaint, DSM Desotech, Elgin, Ill., Chapter 4 of Specialty Optical Fibers Handbook, edited by Alexis Mendez and T. F. Morse, ©2007 by Elsevier Inc., for a succinct summary of these types of oligomers. For further descriptions of Urethane (meth)acrylate oligomers suitable for use in the instant claimed invention please see the U.S. patents, previously listed in this document and previously incorporated by reference.

As stated on pages 103-104 of the article, “Optical Fiber Coatings” as described in the preceding paragraph, Urethane (meth)acrylate oligomers are based on stoichiometric combinations of di-isocyanates (DICs), polyols and some type of hydroxy-functional terminating species containing a UV-reactive terminus . . . . Depending on the properties desired, different types of polyols are chosen. These polyols include, but are not limited to, polyether-polypropylene glycol (PPG) and polyether-polytetramethylene glycol (PTMG) Typically Polyols are used in the synthesis of Urethane (meth)acrylate oligomers.

Petroleum-derived components of urethane (meth)acrylate oligomers such as polyester and polyether polyols pose several disadvantages. Use of such polyester or polyether polyols contributes to the depletion of petroleum-derived oil, which is a non-renewable resource. Also, the production of a polyol requires the investment of a great deal of energy because the oil needed to make the polyol must be drilled, extracted and transported to a refinery where it is refined and processed to purified hydrocarbons that are subsequently converted to alkoxides and finally to the finished polyols. As the consuming public becomes increasingly aware of the environmental impact of this production chain, consumer demand for “greener” products will continue to grow. To help reduce the depletion of petroleum-derived oil whilst satisfying this increasing consumer demand, it would be advantageous to partially or wholly replace petroleum-derived polyester or polyether polyols used in the production of urethane (meth)acrylate oligomers with renewable and more environmentally responsible components.

Reactive Diluent Monomers are well known in the art of radiation curable coatings for optical fiber. See pages 105 of the article entitled “Optical Fiber Coatings” by Steven R. Schmid and Anthony F. Toussaint, DSM Desotech, Elgin, Ill., Chapter 4 of Specialty Optical Fibers Handbook, edited by Alexis Mendez and T. F. Morse, ©2007 by Elsevier Inc., for a succinct summary of these types of reactive diluent monomers. For further descriptions of reactive diluent monomers suitable for use in the instant claimed invention please see the U.S. patents, previously listed in this document and previously incorporated by reference.

In consultation with suppliers of raw materials used in the manufacture of radiation curable coatings for optical fiber it is possible to identify bio-based alternative raw materials for selective inclusion in the coatings. By emphasizing the importance of choosing to synthesized the oligomer and the coating made with the oligomer with bio-based raw materials it is possible to snythesize radiation curable coating for Optical Fiber wherein at least about 15% of the ingredients in the coating are bio-based, rather than petroleum based.

In an embodiment, the radiation curable Optical Fiber coating composition of the instant claimed invention is such that at least about 15% of the ingredients in the coating are bio-based, rather than pertroleum based.

In an embodiment, the radiation curable Optical Fiber coating composition of the instant claimed invention is such that at least about 20% of the ingredients in the coating are bio-based, rather than petroleum based.

In an embodiment, the radiation curable Optical Fiber coating composition of the instant claimed invention is such that at least about 25% of the ingredients in the coating are bio-based, rather than petroleum based.

The compositions of the present invention include a free radical photoinitiator as urethane (meth)acrylate oligomers require a free radical photoinitiator. In general, Photoinitiators are well known in the art of radiation curable coatings for optical fiber. See pages 105 of the article entitled “Optical Fiber Coatings” by Steve R. Schmid and Anthony F. Toussaint, DSM Desotech, Elgin, Ill., Chapter 4 of Specialty Optical Fibers Handbook, edited by Alexis Mendez and T. F. Morse, ©2007 by Elsevier Inc., for a succinct summary of these types of photoinitiators. For further descriptions of photoinitiators suitable for use in the instant claimed invention please see the U.S. patents, previously listed in this document and previously incorporated by reference.

Typically, free radical photoinitiators are divided into those that form radicals by cleavage, known as “Norrish Type I” and those that form radicals by hydrogen abstraction, known as “Norrish type II”. The “Norrish type II” photoinitiators require a hydrogen donor, which serves as the free radical source.

To successfully formulate a radiation curable coating for optical fibers, it is necessary to review the wavelength sensitivity of the photoinitiator(s) present in the coating to determine if they will be activated by the LED light chosen to provide the curing light.

For LED light sources emitting in the 300-475 nm wavelength range, especially those emitting at 365 nm, 390 nm, or 395 nm, examples of suitable photoinitiators absorbing in this area include: benzoylphosphine oxides, such as, for example, 2,4,6-trimethylbenzoyl diphenylphosphine oxide (Lucirin TPO from BASF) and 2,4,6-trimethylbenzoyl phenyl, ethoxy phosphine oxide (Lucirin TPO-L from BASF), bis(2,4,5-trimethylbenzoyl)-phenylphosphineoxide (Irgacure 819 or BAPO from Ciba), 2-methyl-1-[4-(methylthio)phenyl]-2-morpholinopropanone-1 (Irgacure 907 from Ciba), 2-benzyl-2-(dimethylamino)-1-[4-(4-morpholinyl) phenyl]-1-butanone (Irgacure 369 from Ciba), 2-dimethylamino-2-(4-methyl-benzyl)-1-(4-morpholin-4-yl-phenyl)-butan-1-one (Irgacure 379 from Ciba), 4-benzoyl-4′-methyl diphenyl sulphide (Chivacure BMS from Chitec), 4,4′- bis(diethylamino) benzophenone (Chivacure EMK from Chitec), and 4,4′-bis(N,N′-dimethylamino) benzophenone (Michler's ketone). Also suitable are mixtures thereof.

Additionally, photosensitizers are useful in conjunction with photoinitiators in effecting cure with LED light sources emitting in this wavelength range. Examples of suitable photosensitizers include: anthraquinones, such as 2-methylanthraquinone, 2-ethylanthraquinone, 2-tertbutylanthraquinone, 1-chloroanthraquinone, and 2-amylanthraquinone, thioxanthones and xanthones, such as isopropyl thioxanthone, 2-chlorothioxanthone, 2,4-diethylthioxanthone, and 1-chloro-4-propoxythioxanthone, methyl benzoyl formate (Darocur MBF from Ciba), methyl-2-benzoyl benzoate (Chivacure OMB from Chitec), 4-benzoyl-4′-methyl diphenyl sulphide (Chivacure BMS from Chitec), 4,4′-bis(diethylamino)benzophenone (Chivacure EMK from Chitec).

When photosensitizers are employed, other photoinitiators absorbing at shorter wavelengths can be used. Examples of such photoinitiators include benzophenone, such as benzophenone, 4-methyl benzophenone, 2,4,6trimethyl benzophenone, and dimethoxybenzophenone, and, 1-hydroxyphenyl ketones, such as 1-hydroxycyclohexyl phenyl ketone, phenyl (1-hydroxyisopropyl)ketone, 2-hydroxy-1-[4-(2-hydroxyethoxy) phenyl]-2-methyl-1-propanone, and 4-isopropylphenyl(1-hydroxyisoptropyl)ketone, benzil dimethyl ketal, and oligo-[2-hydroxy-2-methyl-1-[4-(1-methylvinyl)phenyl] propanone] (Esacure KIP 150 from Lamberti).

It is possible for LED UV light sources to be designed to emit light at shorter wavelengths. For LED light sources emitting at wavelengths from between about 100 and about 300 nm, photoinitiators absorbing at the shorter wavelengths can be used. Examples of such photoinitiators include: benzophenones, such as benzophenone, 4-methyl benzophenone, 2,4,6-trimethyl benzophenone, and dimethoxybenzophenone, and, 1-hydroxyphenyl ketones, such as 1-hydroxycyclohexyl phenyl ketone, phenyl (1-hydroxyisopropyl)ketone, 2-hydroxy-1-[4-(2-hroxyethoxy) phenyl]-2-methyl-1-propanone, and 4-isopropylphenyl(1-hydroxyisopropyl)ketone, benzil dimethyl ketal, and oligo-[2-hydroxy-2-methyl-1-[4-(1-methylvinyl)phenyl] propanone] (Esacure KIP 150 from Lamberti).

LED light sources can also be designed to emit visible light, which can also be used to cure optical fiber coatings, inks, buffers, and matrix materials. For LED light sources emitting light at wavelengths from about 475 nm to about 900 nm, examples of suitable photoinitiators include: camphorquinone, 4,4′-bis(diethylamino) benzophenone (Chivacure EMK from Chitec), 4,4′-bis(N,N′-dimethylamino) benzophenone (Michler's ketone, bis(2,4,6-trimethylbenzoyl)-phenylphosphineoxide (Irgacure 819 or BAPO from Ciba), metallocenes such as bis(eta 5-2-4-cyclopentadien-1-yl) bis[2,6-difluoro-3-(1H-pyrrol-1-yl) phenyl] titanium (Irgacure 784 from Ciba), and the visible light photoinitiators from Spectra Group Limited, Inc. such as H-Nu 470, H-Nu-535, H-Nu-635, H-Nu-Blue-640, and H-Nu-Blue-660.

In one embodiment of the instant claimed invention, the light emitted by the LED is UVA radiation, which is radiation with a wavelength between about 320 and about 400 nm.

In one embodiment of the instant claimed invention, the light emitted by the LED is UVB radiation, which is radiation with a wavelength between about 280 and about 320 nm.

In one embodiment of the instant claimed invention, the light emitted by the LED is UVC radiation, which is radiation with a wavelength between about 100 and about 280 nm.

In one embodiment of the instant claimed invention, the present composition comprises, relative to the total weight of the composition, from about 0.5 wt % to about 7 wt % of one or more free radical photoinitiators. In one embodiment, the present composition comprises, relative to the total weight of the composition, from about 1 wt % to about 6 wt % of one or more free radical photoinitiators, relative to the total weight of the composition. In another embodiment, the present composition comprises, relative to the total weight of the composition, from about 2 wt % to about 5 wt % of one or more free radical photoinitiators.

Normally, cationic photoinitiators are not required or desired in urethane (meth)acrylate oligomer based radiation curable coatings to function as photoinitiators. It is known however, to use small amounts of commercially available cationic photoinitiators in radiation curable coatings to function chemically as a source of photolatent acid. The photolatent acid has value in the coating as its presence is known to enhance fiber strength. See U.S. Pat. No. 5,181,269.

Optical fiber production process offers a unique condition for LED application. It is well-known that the current LED light (360 nm and longer) can provide good through cure of a coating layer because its longer wave longer wavelength is suitable for good penetration.

Regarding surface cure, it has been noted in LED curing of other types of coatings, that the LED curing results on the surface of the coating is less than satisfactory because of oxygen inhibition. Oxygen inhibition of LED induced surface cure is not an issued in optical fiber production because blanketing the surface of the optical fiber with inert nitrogen gas during cure of the coatings has been standard in the optical fiber industry for some time. In practice for coating optical fibers with radiation curable coatings, the curing environment of the coating is in a controlled, small quartz tube surrounded area with an atmosphere of Nitrogen resulting in very low oxygen levels being present (as low as 20 ppm). Thus LED can offer both good through-cure and good surface cure on optical fiber coatings.

It is anticipated that there will be a transition period for the introduction of LED lamps into the optical fiber industry. During this period, they may be used in conjunction with conventional mercury lamps, rather than completely replacing them. (this paragraph was moved from the background of the invention.)

The measurement of the amount of curing a radiation curable urethane (meth)acrylate based coating has undergone is typically done by conducting a “Percent Reacted Acrylate Unsaturation” (abbreviate “% RAU”) determination. For the coatings of the instant claimed invention, upon curing with an LED light having a wavelength of from about 100 nm to about 900 nm, the % RAU at the top surface of the coating is about 60% or greater, preferably about 70% or greater, more preferably about 75% or greater, more highly preferably about 80% or greater, most preferably about 85% or greater, most highly preferably about 90% or greater, and highest preferably about 95% or greater. It is possible to achieve a % RAU of 100% using LED's to cure the compositions of the instant claimed invention.

It is the top surface of the coating where the % RAU is measured, because as previously described; LED light is expected to provide good through cure. However, the amount of cure at the top surface is critical to reach the indicated level in order to produce viable coated optical fiber.

The seventeenth aspect of the instant claimed invention is a coated optical fiber comprising an optical fiber and at least one coating, wherein said at least one coating is produced by coating the optical fiber with at least one radiation curable coating composition for an optical fiber comprising:
(a) at least one urethane (meth) acrylate oligomer;
(b) at least one reactive monomer; and
(c) at least one photoinitiator;
   to obtain an uncured coated optical fiber, and curing said uncured coated optical fiber by irradiating with a light emitting diode (LED) light having a wavelength from about 100 nm to about 900 nm, to obtain a cured coating having a top surface, said cured coating having a Percent Reacted Acrylate Unsaturation (% RAU) at the top surface of about 60% or greater.

The novel radiation curable compositions of the instant claimed invention may be applied on conventional commercially available optical fiber, bend resistant optical fiber, photonic crystal fiber and they can even be applied on hermetically sealed optical fiber. The radiation curable coatings of the instant claimed invention are viable for application to both Single Mode and MultiMode optical fiber.

In coating an optical fiber, first the optical fiber is drawn on a draw tower and then the Primary Coating is applied, and with wet on dry processing, the next step is for a LED to be used to emit light sufficient to cure the Primary Coating, said cured Primary coating having a Percent Reacted Acrylate Unsaturation (% RAU) at the top surface of about 60% or greater.

With wet on wet processing the next step is to apply the Secondary Coating.

Either way, after the Primary Coating is applied, then the Secondary Coating is applied on top of the Primary Coating, then LED's are used to emit light to cure the radiation curable coating on the optical fiber resulting in the Secondary Coating being cured.

LED's are commercially available. Suppliers of commercially available LED's have been previously listed in this document.

After the Secondary Coating is cured, a layer of “ink coating” is optionally applied and then the coated and inked optical fiber may be further configured into either a Loose Tube configuration or placed alongside other coated and inked optical fibers in a “ribbon assembly” and a radiation curable matrix coating is used to hold the optical fibers in the desired location in the ribbon assembly or into some other type of configuration suitable for deployment in a telecommunications network.

It is also possible that individual coated fibers might be coated with an “upjacketing” coating that increases the outer diameter of the fiber considerably. Fibers that are upjacketed may be inked, colored or clear coated. Upjacketed fibers may be further processed for deployment in a telecommunications network.

It is also possible to bundle fibers together in multiple arrays that may or may not be planar, thus producing an enhanced ribbon structure or blown fiber design.

In one embodiment of the instant claimed invention, the radiation curable coating is being used either as a primary coating, or as a secondary coating, or as a matrix coating, or as an ink coating or as an upjacketing coating.

The nineteenth aspect of the instant claimed invention is a process for coating an optical fiber comprising:
(a) operating a glass draw tower to produce a glass optical fiber;
(b) coating said glass optical fiber with at least one radiation curable coating composition for an optical fiber with at least one radiation curable coating composition for an optical fiber, wherein said at least one radiation curable coating composition comprises:
   (i) at least one urethane (meth)acrylate oligomer;
   (ii) at least one reactive diluent monomer; and
   (iii) at least one photoinitiator;
      to obtain a coated glass optical fiber with an uncured coating, and
(c) curing said uncured coating on said coated glass optical fiber by irradiating said uncured coating with a light emitting diode (LED) light, having a wavelength from about 100 nm to about 900 nm, to obtain a cured coating having a top surface, said cured coating having a % Reacted Acrylate Unsaturation (% RAU) at the top surface of about 60% or greater.

In one embodiment of the process of the third aspect of the instant claimed invention, for application of an Upjacketing Coating the line speed of the optical fiber is at least about 25 m/minute.

In one embodiment of the process of the third aspect of the instant claimed invention, for application of an Upjacketing Coating the line speed of the optical fiber is at least about 100 m/minute.

In one embodiment of the process of the third aspect of the instant claimed invention, for application of the Primary and Secondary Coating the line speed of the optical fiber is at least about 500 m/minute.

In one embodiment of the process of the third aspect of the instant claimed invention, for application of the Primary and Secondary Coating the line speed of the optical fiber is at least about 750 m/minute.

In one embodiment of the process of the third aspect of the instant claimed invention, for application of the Primary and Secondary Coating the line speed of the optical fiber is at least about 1000 m/minute.

In one embodiment of the process of the third aspect of the instant claimed invention, for application of the Ink Coating the line speed of the optical fiber is at no more than about 3000 m/minute.

In one embodiment of the process of the third aspect of the instant claimed invention, for application of the Primary and Secondary Coating the line speed of the optical fiber is at no more than about 2500 m/minute.

In one embodiment of the process of the third aspect of the instant claimed invention, for application of the Primary and Secondary Coating the line speed of the optical fiber is at no more than about 2400 m/minute.

In one embodiment of the process of the third aspect of the instant claimed invention, for application of the Primary and Secondary Coating the line speed of the optical fiber is at no more than about 2300 m/minute.

In one embodiment of the process of the third aspect of the instant claimed invention, for application of the Primary and Secondary Coating the line speed of the optical fiber is at no more than about 2100 m/minute.

In one embodiment of the process of the third aspect of the instant claimed invention, for application of the Primary and Secondary Coating the line speed of the optical fiber is from about 100 m/min to about 2500 m/min for application of the Primary and Secondary. In another embodiment of the process of the third aspect of the instant claimed invention, the line speed of the optical fiber is from about 1000 m/min to about 2400 m/min. In another embodiment of the process of the third aspect of the instant claimed invention, the line speed of the optical fiber is from about 1000 m/min to about 2400 m/min. In another embodiment of the process of the third aspect of the instant claimed invention, the line speed of the optical fiber is from about 1000 m/min to about 2300 m/min. In another embodiment of the process of the third aspect of the instant claimed invention, the line speed of the optical fiber is from about 1,200 m/min to about 2300 m/min. In another embodiment of the process of the third aspect of the instant claimed invention, the line speed of the optical fiber is from about 1,200 m/min to about 2100 m/min.

In one embodiment of the process of the third aspect of the instant claimed invention, for application of the ink layer, the line speed of the optical fiber is between about 500 meters/minute and 3000 meters/minute. In one embodiment of the process of the third aspect of the instant claimed invention, for application of the ink layer, the line speed of the optical fiber is between about 750 meters/minute and 2100 meters/minute.

In one embodiment of the process of the third aspect of the instant claimed invention, for application of the upjacketing coating, the optical fiber is run at a line speed of between about 25 meters/minute and 100 meters/minute.

The specific examples herein disclosed are to be considered as being primarily illustrative. Various changes beyond those described, will, no doubt, occur to those skilled in the art; and such changes are to be understood as forming a part of this invention insofar as they fall within the spirit and scope of the appended claims.

### EXAMPLES

The present invention is further illustrated with a number of examples, which should not be regarded as limiting the scope of the present invention. The components listed in these Examples having the following commercial names, are available from the listed source and have the indicated chemical composition.

TABLE 1
Description of Components Used in the Examples

| | | CAS | |
|---|---|---|---|
| | | Registry | |
| Components | Description | Number | Supplier |
| BHT | 3,5-di-tert-butyl-4- | 128-37-0 | Ashland |
| | hydroxy toluene | | |
| | stabilizer | | |
| Camphorquinone | Camphorquinone | 10373-78-1 | Esstech |
| Chivacure 2-ITX | 2-isopropyl | 83846-86-0 | Chitec |
| | thioxanthone | | |
| | photosensitizer | | |
| Chivacure BMS | 4-benzoyl-4′-methyl | 83846-85-9 | Chitec |
| | diphenyl sulphide | | |
| | photoinitiator | | |
| Chivacure TPO | 2,4,6-trimethylbenzoyl | 75980-60-8 | Chitec |
| | diphenylphosphine | | |
| | oxide photoinitiator | | |
| CN-110 | bisphenol A epoxy | 55818-57-0 | Sartomer |
| | acrylate oligomer | | |
| CN120Z | bisphenol A epoxy | 55818-57-0 | Sartomer |
| | acrylate oligomer | | |
| CN549 | amine-modified | proprietary | Sartomer |
| | polyester tetraacrylate | | |
| CN971A80 | urethane acrylate | proprietary + | Sartomer |
| | oligomer 80% in SR-306 | 42978-66-S | |
| Darocur 1173 | 2-hydroxy-2-methyl- | 7473-98-5 | Ciba |
| | 1-phenyl-1-propanone | | |
| | photoinitiator | | |
| DC-190 | silicone | proprietary | Dow- |
| | | | Corning |
| DC-57 | silicone | proprietary | Dow- |
| | | | Corning |
| Ebecryl 350 | silicone acrylate | proprietary | Cytec |
| Irgacure 184 | 1-hydorxy cyclohexyl | 947-19-3 | Ciba |
| | phenyl ketone | | |
| | photoinitiator | | |
| Irgacure 369 | 2-benzyl-2- | 119313-12-1 | Ciba |
| | (dimethylamino)-1-[4- | | |
| | (4-morpholino) | | |
| | phenyl]-1-butanone | | |
| Irgacure 819 | bis(2,4,6- | 162881-26-7 | Ciba |
| | trimethylbenzoyl)- | | |
| | phenylphosphineoxide | | |
| | photoinitiator | | |
| Irgacure 907 | 2-methyl-1-[4- | 71868-10-5 | Ciba |
| | (methylthio)phenyl]-2- | | |
| | morpholinopropanone- | | |
| | 1 photoinitiator | | |
| Irgacure 2959 | 2-hydroxy-1-[4-(2- | 106797-53-9 | Ciba |
| | hydroxyethoxy) | | |
| | phenyl]-2-merhyl-1- | | |
| | propanone | | |
| Irganox 1035 | thiodiethylene bis- | 41484-35-9 | Ciba |
| | (3,5-di-tert-butyl-4- | | |
| | hydroxy) | | |
| | hydrocinnamate | | |
| | antioxidant | | |
| Oligomer A | PPG/TDI/HEA | proprietary | DSM |
| | urethane acrylate | | Desotech |
| | oligomer, MW = 1580 | | |
| Orange pigment dispersion | cromophtal orange | 72102-84-2 + | DSM |
| | dispersion 20% in SR-351 | 15625-89-5 | Desotech |
| SR-238 | hexanediol diacrylate | 13048-33-4 | Sartomer |
| | monomer | | |
| SR-295 | pentaerythritol | 4986-89-4 + | Sartomer |
| | tetraacylate monomer | 3524-68-3 | |
| SR-306 | tripropylene glycol | 42978-66-5 | Sartomer |
| | diacrylate monomer | | |
| SR-339 | phenoxyethyl acrylate | 48145-04-6 | Sartomer |
| | monomer | | |
| SR-349 | ethoxylated bisphenol | 64401-02-1 | Sartomer |
| | A diacrylate | | |
| SR-351 | trimethylolpropane | 15625-89-5 | Sartomer |
| | triacrylate monomer | | |
| SR-504D | ethoxylated | 678991-31-6 + | Sartomer |
| | nonylphenol acrylate | 127087-87-0 | |
| SR-506 | isobomyl acrylate | 5888-67-1 | Sartomer |
| | monomer | | |
| Tinuvin 123 | bis-(1-octyloxy-2,2,6,6- | 129757-67-1 | Ciba |
| | tetraramethyl-4- | | |
| | piperidinyl) sebacate | | |
| | light stabilizer | | |
| White pigment | titanium dioxide 60% | 13463-67-7 + | DSM |
| dispersion | dispersion in SR-351 | 15625-89-5 | Desotech |

TABLE 2A
Secondary Coatings and Inks Using Summit UV Black Diamond LED
Light Source at 8 m/min in air

| | Example 1 | | | |
|---|---|---|---|---|
| | This is a | | Example 3 | |
| | Comparative | | This is a | |
| | Example cures | Example 2 | Comparative | Example 4 |
| | with Fusion | Example of | Example cures | Example of |
| | Systems 300 | the Invention, | with Fusion | the Invention, |
| | W/in D lamp | cures with | Systems 300 W/in | cures with |
| Components (amounts | Mercury Vapor | LED light at | D lamp Mercury | LED light at |
| in wt. %) | UV light | 365 nm | Vapor UV light | 365 nm |
| Oligomer A | 30.00 | 28.20 | | |
| CN971A80 | | | 16.90 | 16.06 |
| CN-110 | 40.00 | 37.60 | | |
| CN120Z | | | 23.54 | 22.35 |
| SR-295 | | | 12.52 | 11.89 |
| SR-351 | | | 13.00 | 12.35 |
| SR-506 | 7.50 | 7.05 | | |
| SR-339 | 8.50 | 7.99 | | |
| SR-306 | 6.00 | 5.64 | 4.09 | 3.89 |
| SR-238 | 4.50 | 4.23 | 5.96 | 5.66 |
| White pigment | | | 4.00 | 3.80 |
| dispersion | | | | |
| Orange pigment | | | 9.00 | 8.55 |
| dispersion | | | | |
| Chivacure TPO | 0.50 | 0.47 | | |
| Irgacure 184 | 2.00 | 1.88 | | |
| Irgacure 819 | | 1.00 | 1.09 | 1.04 |
| Irgacure 907 | | | 1.92 | 1.82 |
| Darocur 1173 | | | 2.50 | 2.38 |
| Chivacure BMS | | 3.00 | | |
| Chivacure 2-ITX | | | | 2.00 |
| CN549 | | 2.00 | | 3.00 |
| Irganox 1035 | 0.50 | 0.47 | | |
| BHT | | | 0.48 | 0.46 |
| Ebecryl 350 | | | 5.00 | 4.75 |
| DC-190 | 0.33 | 0.31 | | |
| DC-57 | 0.17 | 0.16 | | |
| % RAU at top surface | 42.6 | 69.4 | 50.7 | 61.1 |
| % RAU at bottom | 85.1 | 85.1 | 56.9 | 72.3 |
| surface | | | | |

TABLE 2B
Secondary Coatings and Inks as described in Table 2A Using Phoseon RX
Fireflex LED Light Source at 8 m/min in air

| | | | Example 7 | |
|---|---|---|---|---|
| | | | This is a | Example 8 |
| | Example 5 | Example 6 | Comparative | Example of |
| | This is a | Example of | Example | the |
| | Comparative | the | Formulation of | Invention, |
| | Example | Invention, | Example 3 | Formulation |
| | Formulation of | Formulation | cures | of Example |
| | Example 1 cures | of Example | with Fusion | 4 of the |
| | with Fusion | 2 | Systems 300 | Invention, |
| | Systems 300 W/in | cures with | W/in D lamp | cures with |
| | D lamp Mercury | LED light at | Mercury Vapor | LED light at |
| | Vapor UV light | 395 nm | UV light | 395 nm |
| % RAU | 45.7 | 61.5 | 44.8 | 65.7 |
| at top | | | | |
| surface | | | | |
| % RAU | 88.3 | 91.0 | 73.8 | 80.6 |
| at | | | | |
| bottom | | | | |
| surface | | | | |

TABLE 3
Secondary Coatings Using Summit UV LED Light Source on Ink Line

| | | Example 10 |
|---|---|---|
| | Example 9 | Example of |
| | Comparative Example | the Invention |
| | Formulation of | Formulation |
| | Example 1 cures with | of Example 1, |
| | Fusion Systems 300 W/in D | cures with LED |
| Components | lamp Mercury Vapor UV light | light at 365 nm |
| 25 m/min, nitrogen | | |
| % RAU at top | 71.1 | 91.9 |
| surface | | |
| % RAU at bottom | 88.3 | 94.2 |
| surface | | |
| 200 m/min, nitrogen | | |
| % RAU at top | 52.3 | 74.0 |
| surface | | |
| % RAU at bottom | 81.5 | 82.9 |
| surface | | |
| 300 m/min, nitrogen | | |
| % RAU at top | 40.5 | 66.6 |
| surface | | |
| % RAU at bottom | 69.5 | 75.6 |
| surface | | |

TABLE 4
Inks Using Summit UV LED Light Source on Ink Line

| | Example 11 | |
|---|---|---|
| | Comparative Example | Example 12 |
| | {Formulation of | Formulation of |
| | Example 3} cures | Example |
| | with Fusion Systems | 3 of the Invention, |
| | 300 W/in D lamp | cures with LED light |
| Components | Mercury Vapor UV light. | at 365 nm |
| 200 m/min, nitrogen | | |
| % RAU at top surface | 59.9 | 68.8 |
| 300 m/min, nitrogen | | |
| % RAU at top surface | 48.9 | 64.6 |

TABLE 5
Conventional Curable (Comparative Example)
and LED curable Primary Coating

| | Example 13 | Example 14 |
|---|---|---|
| | Comparative Example | Example of the |
| Components | cures with Fusion | Invention, |
| Components (amounts in | Systems 300 W/in D lamp | cures with LED |
| wt. %) | Mercury Vapor UV light | light at 395 nm |
| Polyether urethane acrylate | 65.1 | 64.1 |
| SR-504D | 21.7 | 21.2 |
| SR-339 | 9.0 | 9.0 |
| SR-349 | 1.0 | 1.0 |
| Irgacure 819 | 1.5 | 1.5 |
| Isopropyl thioxanthone | — | 1.5 |
| Tinuvin 123 | 0.1 | 0.1 |
| Irganox 1035 | 0.6 | 0.6 |
| γ-Mercaptopropyl | 1.0 | 1.0 |
| trimethoxy silane | | |

TABLE 6
Conventional Curable (Comparative Example)
and LED curable Matrix Material

| | | Example 16 |
|---|---|---|
| | Example 15 | Example of the |
| Components | Comparative Example cures | Invention, |
| (amounts in | with Fusion Systems 300 W/in D | cures with LED |
| wt. %) | lamp Mercury Vapor UV light | light at 395 nm |
| Polyether urethane | 27.0 | 25.5 |
| acrylate | | |
| CN120Z | 45.0 | 43.0 |
| SR-339 | 7.7 | 7.7 |
| SR-506 | 6.8 | 6.8 |
| SR-306 | 5.5 | 5.5 |
| SR-238 | 4.0 | 4.0 |
| Irgacure 184 | 2.0 | — |
| Chivacure TPO | 0.5 | — |
| Irgacure 819 | — | 1.0 |
| Chivacure BMS | — | 3.0 |
| CN-549 | — | 2.0 |
| Irganox 1035 | 0.5 | 0.5 |
| DC-190 | 1.0 | 1.0 |

TABLE 7
Conventional Curable (Comparative Example)
and LED curable Buffer Coating

| | | Example 18 |
|---|---|---|
| | Example 17 | Example of the |
| Components | Comparative Example cures | Invention, |
| (amounts in | with Fusion Systems 300 W/in D | cures with LED |
| wt. %) | lamp Mercury Vapor UV light | light at 395 nm |
| Polyether urethane | 35.0 | 34.0 |
| acrylate | | |
| CN120Z | 26.0 | 26.0 |
| SR-306 | 33.0 | 32.0 |
| Darocur 1173 | 4.0 | — |
| Irgacure 819 | — | 1.0 |
| Chivacure BMS | — | 3.0 |
| CN-549 | — | 2.0 |
| DC-190 | 2.0 | 2.0 |

TABLE 8
Conventional Curable (Comparative Example) and LED
curable Buffer Coating cures with visible LED light source

| | | Example 20 |
|---|---|---|
| | Example 19 | Example of the |
| Components | Comparative Example cures | Invention, |
| (amounts in | with Fusion Systems 300 W/in D | cures with LED |
| wt. %) | lamp Mercury Vapor UV light | light at 455 nm |
| Polyether urethane | 35.0 | 34.0 |
| acrylate | | |
| CN120Z | 26.0 | 26.0 |
| SR-306 | 33.0 | 32.0 |
| Darocur 1173 | 4.0 | — |
| Camphorquinone | — | 4.0 |
| CN-549 | — | 2.0 |
| DC-190 | 2.0 | 2.0 |

TABLE 9
Conventional Curable (Comparative Example) and LED
curable Buffer Coating cures with UVB LED light source

| | | Example 22 |
|---|---|---|
| | Example 21 | Example of the |
| Components | Comparative Example cures | Invention, |
| (amounts in | with Fusion Systems 300 W/in D | cures with LED |
| wt. %) | lamp Mercury Vapor UV light | light at 285 nm |
| Polyether urethane | 35.0 | 35.0 |
| acrylate | | |
| CN120Z | 26.0 | 26.0 |
| SR-306 | 33.0 | 33.0 |
| Darocur 1173 | 4.0 | — |
| Irgacure 819 | — | 1.0 |
| Irgacure 2959 | — | 3.0 |
| DC-190 | 2.0 | 2.0 |

TABLE 10
Conventional Curable (Comparative Example) and LED
curable Buffer Coating cures with UVC LED light source

| | | Example 23 |
|---|---|---|
| Components | Example 22 | Example of the |
| Components | Comparative Example cures | Invention, |
| (amounts in | with Fusion Systems 300 W/in D | cures with LED |
| wt. %) | lamp Mercury Vapor UV light | light at 210 nm |
| Polyether urethane | 35.0 | 35.0 |
| acrylate | | |
| CN120Z | 26.0 | 26.0 |
| SR-306 | 33.0 | 33.0 |
| Darocur 1173 | 4.0 | — |
| Chivacure TPO | — | 1.0 |
| Irgacure 369 | — | 3.0 |
| DC-190 | 2.0 | 2.0 |

TABLE 11
Example 24 Secondary Coatings for Optical Fiber, curable with a 395 nm LED light source

| | Example 24A | | | | | | |
|---|---|---|---|---|---|---|---|
| | Comparative | | | | | | |
| | Example, NOT | Example | Example | Example | Example | Example | Example |
| | LED curable | 24B | 24C | 24D | 24E | 24F | 24G |
| Components | wt. % | wt. % | wt. % | wt. % | wt. % | wt. % | wt. % |
| PPG/TDI/HEA | 30.00 | 28.20 | 29.00 | 30.00 | 30.20 | 29.00 | 30.00 |
| CN-110 | 40.00 | 37.60 | 38.00 | | 15.00 | 38.00 | |
| CN120Z | | | | 40.00 | 15.00 | | 40.00 |
| Isobornyl acrylate | 7.50 | 7.05 | 7.00 | 7.50 | 7.05 | 7.00 | 7.50 |
| Phenoxyethyl acrylate | 8.50 | 7.99 | 8.50 | 8.50 | 7.99 | 8.50 | 8.50 |
| Tripropylene glycol diacrylate | 6.00 | 5.64 | 7.00 | 6.00 | 5.64 | 7.00 | 6.00 |
| Hexanediol diacrylate | 4.50 | 4.23 | 5.00 | 4.50 | 4.23 | 5.00 | 4.50 |
| Chivacure TPO | 0.50 | 0.47 | | | 0.47 | | |
| Lucirin TPO-L | | | 1.00 | | | 1.00 | |
| Irgacure 184 | 2.00 | 1.88 | | 0.50 | 1.88 | | 0.50 |
| Irgacure 819 | | 1.00 | 0.50 | 0.50 | 1.00 | 0.50 | 0.50 |
| Irgacure 907 | | | 0.50 | 1.00 | | 0.50 | 1.00 |
| Esacure KIP 100F | | | 2.00 | | | 2.00 | |
| Chivacure BMS | | 3.00 | 0.50 | | 3.00 | 0.50 | |
| Chivacure 2-ITX | | | | 0.50 | | | 0.50 |
| CN549 | | 2.00 | | | 2.00 | | |
| Irganox 1035 | 0.50 | 0.47 | 0.50 | 0.50 | 0.47 | 0.50 | 0.50 |
| DC-190 | 0.33 | 0.31 | 0.33 | 0.33 | 0.31 | 0.33 | 0.33 |
| DC-57 | 0.17 | 0.16 | 0.17 | 0.17 | 0.16 | 0.17 | 0.17 |
| Total | 100.00 | 100.00 | 100.00 | 100.00 | 100.00 | 100.00 | 100.00 |

TABLE 12
Example 25 Another Secondary Coating For Optical Fiber that is LED Curable

| | Example | Example | Example | Example | Example |
|---|---|---|---|---|---|
| Components (in wt. %) | 25A | 25B | 25C | 25D | 25E |
| PPG1000/TDI/HEA | 23.47 | 23.47 | 23.47 | 23.47 | 23.47 |
| HHPA/Epon S28/HEA | 19.78 | 19.78 | 19.78 | 19.78 | 19.78 |
| CN120Z | 22.70 | 20.00 | 25.37 | 20.00 | 26.83 |
| 4EO bisphenol A diacrylate | | | | | 6.00 |
| 10EO bisphenol A diacrylate | | | | 6.00 | |
| PEG400 diacrylate | | | 6.00 | | |
| Isobornyl acrylate | 5.97 | | | | |
| Phenoxyethyl acrylate | | 6.00 | | | |
| Tripropylene glycol diacrylate | 22.70 | 24.43 | 20.00 | 26.00 | 18.00 |
| Hexanediol diacrylate | | | | | |
| Chivacure TPO | | 0.50 | | 1.00 | 3.00 |
| Lucirin TPO-L | 1.00 | 1.00 | 1.00 | 1.00 | 0.25 |
| Irgacure 184 | | 0.50 | | | |
| Irgacure 819 | 0.50 | 0.94 | 0.50 | 0.25 | 0.29 |
| Irgacure 907 | 0.50 | | 0.50 | 0.25 | 0.50 |
| Esacure KIP100F | 2.00 | 2.00 | 2.00 | 0.87 | 0.50 |
| Chivacure BMS | 0.50 | 0.50 | 0.50 | 0.50 | 0.50 |
| CN549 | | | | | |
| Irganox 1035 | 0.50 | 0.50 | 0.50 | 0.50 | 0.50 |
| DC-190 | 0.25 | 0.25 | 0.25 | 0.25 | 0.25 |
| DC-57 | 0.13 | 0.13 | 0.13 | 0.13 | 0.13 |
| Total | 100.00 | 100.00 | 100.00 | 100.00 | 100.00 |

TABLE 13
Example 26 Another Secondary Coating For Optical
Fiber that is LED Curable at 395 nm.

| | Example | Example | Example | Example | Example |
|---|---|---|---|---|---|
| | 26A | 26B | 26C | 26D | 26E |
| Components | wt. % | wt. % | wt. % | wt. % | wt. % |
| Bomar KWS 4131 | 10.00 | 10.00 | 10.00 | 10.00 | 10.00 |
| CN-110 | | 2.50 | 5.00 | 5.00 | 7.50 |
| CN120Z | 5.00 | 2.50 | | 5.00 | 7.50 |
| 4EO bisphenol A diacrylate | 80.00 | 70.00 | 75.00 | 60.00 | 70.00 |
| 10EO bisphenol A diacrylate | | 1.00 | | 5.00 | |
| PEG400 diacrylate | | 1.75 | | 2.50 | |
| Isobornyl acrylate | | 2.00 | | 2.50 | |
| Phenoxyethyl acrylate | | 2.25 | 5.00 | 2.50 | |
| Tripropylene glycol diacrylate | | 3.00 | | | |
| Hexanediol diacrylate | | | | 2.50 | |
| Chivacure TPO | | 0.50 | 1.00 | 0.33 | 1.00 |
| Lucirin TPO-L | 1.00 | 1.00 | 1.00 | 0.33 | 1.00 |
| Irgacure 184 | | | | 0.34 | |
| Irgacure 819 | 0.50 | 0.50 | 0.50 | 0.50 | 0.50 |
| Irgacure 907 | 0.50 | | 0.50 | 0.50 | 0.50 |
| Esacure KIP100F | 2.00 | 2.00 | 1.00 | 2.00 | 1.00 |
| Chivacure BMS | 0.50 | 0.50 | 0.50 | 0.50 | 0.50 |
| CN549 | | | | | |
| Irganox 1035 | 0.50 | | 0.50 | 0.12 | 0.25 |
| Irganox 1076 | | 0.25 | | 0.13 | 0.12 |
| Irganox 1010 | | 0.25 | | 0.25 | 0.33 |
| Total | 100.00 | 100.00 | 100.00 | 100.00 | 100.00 |

TABLE 14
Example 27 Another Secondary Coating For Optical
Fiber that is LED Curable at 395 nm.

| | Example | Example | Example | Example | Example |
|---|---|---|---|---|---|
| | 27A | 27B | 27C | 27D | 27E |
| Components | wt. % | wt. % | wt. % | wt. % | wt. % |
| PTHF 650/TDI/HEA | 38.00 | 19.00 | 19.00 | 20.00 | 12.00 |
| PTHF/IPDI/HEA | | 19.00 | | | 12.00 |
| PTHF/adipic acid/IPDI/HEA | | | 19.00 | | 12.00 |
| PTHF/IPDI/TDI/HEA | | | | 18.00 | 2.00 |
| CN-110 | | 14.00 | | 28.00 | 14.00 |
| CN120Z | 28.00 | 14.00 | 28.00 | | 14.00 |
| PEG400 diacrylate | | 8.50 | 8.50 | | |
| Isobornyl acrylate | 10.00 | 10.00 | 10.00 | 10.00 | 10.00 |
| Phenoxyethyl acrylate | 10.00 | 10.00 | 10.00 | 10.00 | 10.00 |
| Tripropylene glycol diacrylate | | | | | |
| Hexanediol diacrylate | 8.50 | | | 8.50 | 8.50 |
| Chivacure TPO | | 1.00 | 1.00 | | |
| Lucirin TPO-L | 1.00 | 1.00 | 1.00 | 0.50 | 0.50 |
| Irgacure 184 | | | | 0.50 | 0.50 |
| Irgacure 819 | 0.50 | 0.50 | 0.50 | 0.50 | 0.50 |
| Irgacure 907 | 0.50 | 0.50 | 0.50 | 0.50 | 0.50 |
| Esacure KIP100F | 2.00 | 0.50 | 0.50 | 2.00 | 2.00 |
| Chivacure BMS | 0.50 | 1.00 | 1.00 | 0.50 | 0.50 |
| Irganox 1035 | 0.50 | | 0.50 | | |
| Irganox 1076 | | 0.25 | | 0.25 | 0.25 |
| Irganox 1010 | | 0.25 | | 0.25 | 0.25 |
| DC-190 | 0.33 | 0.33 | 0.33 | 0.33 | 0.33 |
| DC-57 | 0.17 | 0.17 | 0.17 | 0.17 | 0.17 |
| Total | 100.00 | 100.00 | 100.00 | 100.00 | 100.00 |

TABLE 15
Example 28 Another Secondary Coating For
Optical Fiber that is LED Curable at 395 nm.

| | Example | Example | Example | Example | Example |
|---|---|---|---|---|---|
| | 28A | 28B | 28C | 28D | 28E |
| Components | wt. % | wt. % | wt. % | wt. % | wt. % |
| PTHF/adipic acid/IPDI/HEA | 48.50 | 48.50 | 48.50 | 48.50 | 48.50 |
| CN-110 | | 11.90 | 21.90 | 15.00 | 17.00 |
| CN120Z | 21.90 | 10.00 | | 6.90 | 4.90 |
| Tripropylene glycol diacrylate | 2.50 | 2.50 | 2.50 | 2.50 | 2.50 |
| Hexanediol diacrylate | 20.60 | 20.60 | 20.60 | 20.60 | 20.60 |
| Chivacure TPO | | 1.00 | 1.00 | | |
| Lucirin TPO-L | 1.00 | 1.00 | 1.00 | 0.50 | 0.50 |
| Irgacure 184 | | | | 0.50 | 0.50 |
| Irgacure 819 | 0.50 | 0.50 | 0.50 | 0.50 | 0.50 |
| Irgacure 907 | 0.50 | 0.50 | 0.50 | 0.50 | 0.50 |
| Esacure KIP100F | 2.00 | 0.50 | 0.50 | 2.00 | 2.00 |
| Chivacure BMS | 0.50 | 1.00 | 1.00 | 0.50 | 0.50 |
| Irganox 1035 | 1.70 | | 1.00 | | |
| Irganox 1076 | | 0.85 | 0.70 | | 1.50 |
| Irganox 1010 | | 0.85 | | 1.70 | 0.20 |
| DC-190 | 0.20 | 0.20 | 0.20 | 0.20 | 0.20 |
| DC-57 | 0.10 | 0.10 | 0.10 | 0.10 | 0.10 |
| Total | 100.00 | 100.00 | 100.00 | 100.00 | 100.00 |

TABLE 16
Example 29 Another Secondary Coating For
Optical Fiber that is LED Curable at 395 nm

| | Example | Example | Example | Example | Example |
|---|---|---|---|---|---|
| | 29A | 29B | 29C | 29D | 29E |
| Components | wt. % | wt. % | wt. % | wt. % | wt. % |
| PPG1000/TDI/HEA | | | 10.00 | 21.20 | |
| PTHF 650/TDI/HEA | | 11.20 | | | |
| PTHF/IPDI/HEA | 21.20 | 10.00 | 11.20 | 5.00 | 21.20 |
| CN-110 | | | 15.00 | | 30.00 |
| CN120Z | 30.00 | 30.00 | 15.00 | 25.00 | |
| 4EO bisphenol A diacrylate | | 6.00 | | | |
| 10EO bisphenol A diacrylate | 11.00 | 5.00 | 11.00 | 10.00 | 11.00 |
| PEG400 diacrylate | 6.00 | 6.00 | 6.00 | 6.00 | 6.00 |
| Isobornyl acrylate | | | | | |
| Phenoxyethyl acrylate | 12.00 | 12.00 | 12.00 | 12.00 | 12.00 |
| Tripropylene glycol diacrylate | | 7.00 | | 3.00 | 10.00 |
| Hexanediol diacrylate | 14.00 | 7.00 | 14.00 | 11.00 | 4.00 |
| Chivacure TPO | | 1.00 | 1.00 | | |
| Lucirin TPO-L | 1.00 | 1.00 | 1.00 | 0.50 | 0.50 |
| Irgacure 184 | | | | 0.50 | 0.50 |
| Irgacure 819 | 0.50 | 0.50 | 0.50 | 0.50 | 0.50 |
| Irgacure 907 | 0.50 | 0.50 | 0.50 | 0.50 | 0.50 |
| Esacure KIP100F | 2.00 | 0.50 | 0.50 | 3.00 | 2.00 |
| Chivacure BMS | 0.50 | 1.00 | 1.00 | 0.50 | 0.50 |
| Irganox 1035 | | 0.50 | 0.40 | 0.25 | |
| Irganox 1076 | 0.50 | | 0.50 | 0.25 | 0.50 |
| Irganox 1010 | 0.40 | 0.40 | | 0.40 | 0.40 |
| DC-190 | 0.20 | 0.20 | 0.20 | 0.20 | 0.20 |
| DC-57 | 0.20 | 0.20 | 0.20 | 0.20 | 0.20 |
| Total | 100.00 | 100.00 | 100.00 | 100.00 | 100.00 |

TABLE 17
Example 30 Another Secondary Coating For
Optical Fiber that is LED Curable at 395 nm

| | Example 30 | Example 30A | Example 30B | Example 30C | Example 30D |
|---|---|---|---|---|---|
| Components | wt. % | wt. % | wt. % | wt. % | wt. % |
| PTHF 650/TDI/HEA | | 27.00 | | | |
| PTHF/IPDI/HEA | | 26.00 | | 25.00 | |
| PTHF/adipic acid/IPDI/HEA | | | 26.00 | | |
| PTHF/IPDI/TDI/HEA | 53.00 | | 27.00 | 27.00 | 53.00 |
| CN-110 | | 8.10 | | 7.00 | |
| CN120Z | 17.20 | 7.00 | 17.20 | 10.20 | 17.20 |
| Isobornyl acrylate | 12.00 | 12.00 | 12.00 | 12.00 | 12.00 |
| Phenoxyethyl acrylate | 10.00 | 10.00 | 10.00 | 10.00 | 10.00 |
| Tripropylene glycol diacrylate | 2.00 | 2.00 | 2.00 | 1.10 | 2.00 |
| Chivacure TPO | | 1.00 | 1.00 | | |
| Lucirin TPO-L | 1.00 | 1.00 | 1.00 | 0.50 | 0.50 |
| Irgacure 184 | | | | 0.50 | 0.50 |
| Irgacure 819 | 0.50 | 0.50 | 0.50 | 0.50 | 0.50 |
| Irgacure 907 | 0.50 | 0.50 | 0.50 | 0.50 | 0.50 |
| Esacure KIP100F | 2.00 | 0.50 | 0.50 | 3.00 | 2.00 |
| Chivacure BMS | 0.50 | 1.00 | 1.00 | 0.50 | 0.50 |
| Irganox 1035 | 1.20 | 1.20 | | | 1.20 |
| Irganox 1076 | | 0.60 | 1.20 | | |
| Irganox 1010 | | 0.60 | | 1.20 | |
| DC-190 | 0.10 | 0.50 | | 0.50 | 0.10 |
| DC-57 | | 0.50 | 0.10 | 0.50 | |
| Total | 100.00 | 100.00 | 100.00 | 100.00 | 100.00 |

TABLE 18
Example 31 Primary Coating Suitable for LED cure

| | Example 31A | Example 31B |
|---|---|---|
| Components | wt. % | wt. % |
| Acclaim PPG 4200/TDI/HEA | 47.05 | |
| Acclaim PPG 4200/Priplast | | 47.00 |
| 3190/IPDI/HEA | | |
| 3EO bisphenol A diacrylate | 0.84 | 0.84 |
| Ethoxylated nonylphenol acrylate | 43.62 | |
| Propoxylated nonylphenol acrylate | | 43.64 |
| Lucirin TPO-L | 5.00 | 5.00 |
| Irgacure 819 | 2.00 | 2.00 |
| Irganox 1035 | 0.47 | |
| Irganox 1076 | | 0.50 |
| Tinuvin 123 | 0.09 | 0.09 |
| A-189 | 0.93 | 0.93 |
| Total | 100.00 | 100.00 |

TABLE 19
Example 32 Primary Coating Suitable for LED cure

| | Example | Example |
|---|---|---|
| | 32A | 32B |
| Components | wt. % | wt. % |
| Acclaim PPG 4200/TDI/HEA | 47.56 | |
| PPG/IPDI/HEA | | 45.47 |
| 3EO bisphenol A diacrylate | 0.85 | |
| 10EO bisphenol A diacrylate | | 1.00 |
| Ethoxylated nonylphenol acrylate | 44.09 | |
| Propoxylated nonylphenol | | 46.00 |
| acrylate | | |
| Lucirin TPO-L | 5.00 | 5.00 |
| Irgacure 819 | 1.00 | 1.00 |
| Irganox 3790 | | 0.50 |
| Irganox 1035 | 0.47 | |
| Irganox 1076 | | |
| Tinuvin 123 | 0.09 | 0.09 |
| A-189 | 0.94 | 0.94 |
| Total | 100.00 | 100.00 |

TABLE 20
Example 33 Primary Coating Suitable for LED cure with a 395 nm LED
array.

| | Example | Example |
|---|---|---|
| | 33A | 33B |
| Components | wt. % | wt. % |
| PPG2000IPDI/TDI/HEA | 47.00 | 45.80 |
| Tripropylene glycol diacrylate | 0.80 | 0.80 |
| Ethoxylated nonylphenol acrylate | 43.80 | |
| Propoxylated nonylphenol | | 45.00 |
| acrylate | | |
| Lucirin TPO-L | 5.00 | 5.00 |
| Irgacure 819 | 2.00 | 2.00 |
| Irganox 3790 | | 0.25 |
| Irganox 1035 | 0.50 | |
| Irganox 1076 | | 0.25 |
| A-189 | 0.90 | 0.90 |
| Total | 100.00 | 100.00 |

TABLE 21
Example 34 Primary Coating Suitable for LED cure

| | Example | Example |
|---|---|---|
| | 34A | 34B |
| Components | wt. % | wt. % |
| BR-3741 | 48.00 | |
| PPG4000/TDS/HEA diblock | | 24.00 |
| PPG/IPDI/HEA | | 24.00 |
| Ethoxylated nonylphenol acrylate | 38.11 | |
| Propoxylated nonylphenol | | 38.10 |
| acrylate | | |
| Caprolactone acrylate | 4.90 | 2.45 |
| Vinyl caprolactam | | 2.45 |
| Lucirin TPO-L | 5.00 | 5.00 |
| Irgacure 819 | 2.00 | 2.00 |
| Irganox 3790 | | 0.33 |
| Irganox 1035 | 0.98 | 0.33 |
| Irganox 1076 | | 0.33 |
| 2-acryloxypropyl trimethoxy | 0.98 | 0.98 |
| silane | | |
| Pentacrythritol tetrakis (3- | 0.03 | 0.03 |
| mercaptopropionate) | | |
| Total | 100.00 | 100.00 |

TABLE 22
Example 35 Primary Coating Suitable for LED cure

Example 35

| | | Example |
|---|---|---|
| | Example 35A | 35B |
| Components | wt. % | wt. % |
| Acclaim PPG 4200/TDI/HEA | 66.00 | 30.00 |
| Acclaim PPG 4200/Priplast | | 30.00 |
| 3190/IPDI/HEA | | |
| 3EO bisphenol A diacrylate | 5.50 | 10.50 |
| Ethoxylated nonylphenol acrylate | 11.15 | 6.00 |
| Propoxylated nonylphenol acrylate | | 6.15 |
| Caprolactone acrylate | | |
| Isodecyl acrylate | 9.80 | 4.90 |
| Tridecyl acrylate | | 4.90 |
| Lucirin TPO-L | 4.00 | 4.00 |
| Irgacure 819 | 1.00 | 1.00 |
| Irganox 3790 | | 0.25 |
| Irganox 1035 | 0.75 | 0.25 |
| Irganox 1076 | | 0.25 |
| Tinuvin 123 | 0.40 | 0.40 |
| Lowilite 20 | 0.15 | 0.15 |
| A-189 | 1.25 | 1.25 |
| Total | 100.00 | 100.00 |

TABLE 23
Example 36 Primary Coating Suitable for LED cure

| | Example | Example |
|---|---|---|
| | 36A | 36B |
| Components | wt. % | wt. % |
| PPG4000/TDS/HEA diblock | 66.00 | 33.00 |
| PPG2000/TDS/HEA | | 33.00 |
| 3EO bisphenol A diacrylate | 5.00 | 2.50 |
| 10EO bisphenol A diacrylate | | 2.50 |
| Ethoxylated nonylphenol acrylate | 10.10 | 5.05 |
| Propoxylated nonylphenol | | 5.05 |
| acrylate | | |
| Isodecyl acrylate | 11.60 | 5.80 |
| Tridecyl acrylate | | 5.80 |
| Lucirin TPO-L | 4.00 | 4.00 |
| Irgacure 819 | 1.00 | 1.00 |
| Irganox 3790 | | 0.25 |
| Irganox 1035 | 0.75 | 0.25 |
| Irganox 1076 | | 0.25 |
| Tinuvin 123 | 0.40 | 0.40 |
| Lowilite 20 | 0.15 | 0.15 |
| A-189 | 1.00 | 1.00 |
| Total | 100.00 | 100.00 |

TABLE 24
Example 37 Primary Coatings Suitable for LED cure

| | Example | Example |
|---|---|---|
| | 37A | 37B |
| Components | wt. % | wt. % |
| PPG2000/TDS/HEA | 63.00 | 30.00 |
| PPG/PTHF/IPDI/HEA | | 33.00 |
| Phenoxyethyl acrylate | 3.00 | 3.00 |
| Tripropylene glycol diacrylate | 1.00 | 1.00 |
| Ethoxylated nonylphenol acrylate | 19.25 | 10.00 |
| Propoxylated nonylphenol | | 9.25 |
| acrylate | | |
| Vinyl caprolactam | 6.50 | 6.50 |
| Lucirin TPO-L | 4.00 | 4.00 |
| Irgacure 819 | 1.00 | 1.00 |
| Irganox 3790 | | 0.20 |
| Irganox 1035 | 0.60 | 0.20 |
| Irganox 1076 | | 0.20 |
| Lowilite 20 | 0.15 | 0.15 |
| A-189 | 1.50 | 1.50 |
| Total | 100.00 | 100.00 |

TABLE 25
Example 38 Primary Coatings Suitable for LED cure

| | Example | Example |
|---|---|---|
| | 38A | 38B |
| Components | wt. % | wt. % |
| PPG2000/TDS/HEA | 56.00 | 28.00 |
| PPG/IPDI/HEA | | 28.00 |
| Tripropylene glycol diacrylate | 0.50 | 0.50 |
| Ethoxylated nonylphenol acrylate | 29.75 | 15.00 |
| Propoxylated nonylphenol | | 14.75 |
| acrylate | | |
| Vinyl caprolactam | 6.50 | 6.50 |
| Lucirin TPO-L | 4.00 | 4.00 |
| Irgacure 819 | 1.00 | 1.00 |
| Irganox 3790 | | 0.20 |
| Irganox 1035 | 0.60 | 0.20 |
| Irganox 1076 | | 0.20 |
| Lowilite 20 | 0.15 | 0.15 |
| A-189 | 1.50 | 1.50 |
| Total | 100.00 | 100.00 |

TABLE 26
Example 39 Primary Coatings Suitable for LED cure

| | Example | Example |
|---|---|---|
| | 39A | 39B |
| Components | wt. % | wt. % |
| PPG2000/TDS/HEA | | 33.00 |
| Acclaim PPG 4200/Priplast | 66.00 | 33.00 |
| 3190/IPDI/HEA | | |
| 3EO bisphenol A diacrylate | 3.20 | 3.20 |
| Ethoxylated nonylphenol acrylate | 10.00 | 5.00 |
| Propoxylated nonylphenol | | 5.00 |
| acrylate | | |
| Tridecyl acrylate | 7.00 | 7.00 |
| Vinyl caprolactam | 6.00 | 6.00 |
| Lucirin TPO-L | 4.00 | 4.00 |
| Irgacure 819 | 1.00 | 1.00 |
| Irganox 3790 | 1.40 | 0.40 |
| Irganox 1035 | | 0.50 |
| Irganox 1076 | | 0.50 |
| Tinuvin 123 | 0.40 | 0.40 |
| A-189 | 1.00 | 1.00 |
| Total | 100.00 | 100.00 |

TABLE 27
Example 40 Primary Coatings Suitable for LED cure

| | Example | |
|---|---|---|
| | 40A | Example 40B |
| Components | wt. % | wt. % |
| Acclaim PPG 4200/Priplast | | 25.50 |
| 3190/IPDI/HEA | | |
| PTHF/Desmodur W/IPDI/HEA | 50.50 | 25.00 |
| Ethoxylated nonylphenol acrylate | | 19.30 |
| Propoxylated nonylphenol | 38.60 | 19.30 |
| acrylate | | |
| Lucirin TPO-L | 4.00 | 4.00 |
| Irgacure 819 | 1.00 | 1.00 |
| Irganox 3790 | | 0.40 |
| Irganox 1035 | 1.10 | 0.35 |
| Irganox 1076 | | 0.35 |
| Isooctyl-3-mercaptopropionate | 4.30 | 4.30 |
| A-189 | 0.50 | 0.50 |
| Total | 100.00 | 100.00 |

TABLE 28
Example 41 Primary Coatings Suitable for LED cure

| | Example | Example |
|---|---|---|
| | 41A | 41B |
| Components | wt. % | wt. % |
| PPG/PTHF/IPDI/HEA | 37.20 | 20.00 |
| PPG/IPDI/HEA | | 17.20 |
| 10EO bisphenol A diacrylate | 3.00 | 3.00 |
| Phenoxyethyl acrylate | 25.00 | 25.00 |
| Tripropylene glycol diacrylate | | |
| Ethoxylated nonylphenol acrylate | 28.00 | 14.00 |
| Propoxylated nonylphenol | | 14.00 |
| acrylate | | |
| Lucirin TPO-L | 4.00 | 4.00 |
| Irgacure 819 | 1.00 | 1.00 |
| Irganox 3790 | | 0.30 |
| Irganox 1035 | | 0.30 |
| Irganox 1076 | 0.80 | 0.20 |
| A-189 | 1.00 | 1.00 |
| Total | 100.00 | 100.00 |

TABLE 29
Example 42 Primary Coatings Suitable for LED cure

| | Example 42A | Example 42B |
|---|---|---|
| Components | wt. % | wt. % |
| PPG/PTHF/IPDI/HEA | | 39.00 |
| PPG/IPDI/HEA | 69.00 | 30.00 |
| 3EO bisphenol A diacrylate | 8.50 | 4.50 |
| 10EO bisphenol A diacrylate | | 4.00 |
| Ethoxylated nonylphenol acrylate | 12.60 | 6.60 |
| Propoxylated nonylphenol | | 6.00 |
| acrylate | | |
| Vinyl caprolactam | 1.40 | 1.40 |
| Lucirin TPO-L | 4.00 | 4.00 |
| Irgacure 819 | 1.00 | 1.00 |
| Irganox 3790 | | 1.00 |
| Irganox 1035 | 2.50 | 1.00 |
| Irganox 1076 | | 0.50 |
| A-189 | 1.00 | 1.00 |
| Totals | 100.00 | 100.00 |

TABLE 30

| | Example 43 | | | | |
|---|---|---|---|---|---|
| | Example 43A | Example 43B | Example 43C | Example 43D | Example 43E |
| Components | wt. % | wt. % | wt. % | wt. % | wt. % |
| PPG/TDI/HEA | | 4.38 | 10.00 | | |
| CN971A80 | 16.06 | 10.00 | 5.06 | 10.00 | 16.06 |
| Acclaim PPG 4200/TDI/HEA | | 10.00 | 5.00 | 6.06 | 11.35 |
| CN-110 | | 2.00 | 5.00 | | 11.00 |
| CN120Z | 22.35 | 22.35 | 22.35 | 22.35 | |
| Pentaerythritol triacrylate | 11.89 | 3.89 | 11.89 | 11.89 | 11.89 |
| Trimethylpropane triacrylate | 12.35 | 8.65 | 12.35 | 0.00 | 8.35 |
| Isobornyl acrylate | | | | 10.35 | |
| Tripropylene glycol diacrylate | 3.89 | 3.89 | 3.89 | 3.89 | 3.89 |
| Hexanediol diacrylate | 5.66 | 5.66 | 5.66 | 5.66 | 5.66 |
| Ethoxylated nonylphenol acrylate | | | | | |
| White pigment dispersion | 3.80 | 3.80 | 3.80 | 3.80 | 3.80 |
| Orange pigment dispersion | 8.55 | 8.55 | 8.55 | 8.55 | 8.55 |
| Chivacure TPO | | | | | 2.00 |
| Lucirin TPO-L | | | 1.00 | | 1.00 |
| Irgacure 184 | | 1.38 | | 2.00 | 1.00 |
| Irgacure 819 | 1.04 | 1.04 | 1.04 | 1.04 | 1.04 |
| Irgacure 907 | 1.82 | 1.82 | 1.82 | 1.82 | 1.82 |
| Darocur 1173 | 2.38 | 2.38 | 2.38 | 2.38 | 2.38 |
| Chivacure 2-ITX | 2.00 | 2.00 | 2.00 | 2.00 | 2.00 |
| CN549 | 3.00 | 3.00 | 3.00 | 3.00 | 3.00 |
| Irganox 1035 | | | | | |
| BHT | 0.46 | 0.46 | 0.46 | 0.46 | 0.46 |
| Ebecryl 350 | 4.75 | 4.75 | 4.75 | 4.75 | 4.75 |
| total | 100.00 | 100.00 | 100.00 | 100.00 | 100.00 |

TABLE 31

| | Example 44 | | | | |
|---|---|---|---|---|---|
| | Example 44A- | | | | |
| | Comparative | | | | |
| | Example not an | | | | |
| | example of the | | | Example | Example |
| | invention | Example 44B | Example 44C | 44D | 44E |
| Components | wt. % | wt. % | wt. % | wt. % | wt. % |
| PPG/TDI/HEA | | | 11.00 | | |
| CN971A80 | 16.90 | 16.90 | 5.90 | 16.90 | 6.00 |
| Acclaim PPG 4200/TDI/HEA | | | 5.50 | | 10.90 |
| CN-110 | | 11.00 | 5.50 | | |
| CN120Z | 23.54 | 12.54 | 23.54 | 23.54 | 23.54 |
| Ethoxylated bisphenol A diacrylate | | | 8.34 | | |
| Pentaerythritol triacrylate | 12.52 | 12.52 | 4.18 | 12.52 | 12.52 |
| Trimethylpropane triacrylate | 13.00 | 13.00 | 13.00 | | 13.00 |
| Isobornyl acrylate | | | | 6.50 | |
| Phenoxyethyl acrylate | | | | 6.50 | |
| Tripropylene glycol diacrylate | 4.09 | 4.09 | 4.09 | 4.09 | 4.09 |
| Hexanediol diacrylate | 5.96 | 3.00 | 5.96 | 5.96 | 5.96 |
| Ethoxylated nonylphenol acrylate | | 2.96 | | | |
| White pigment dispersion | 4.00 | 4.00 | 4.00 | 4.00 | 4.00 |
| Orange pigment dispersion | 9.00 | 9.00 | 9.00 | 9.00 | 9.00 |
| Irgacure 184 | | | 1.92 | 1.25 | 2.50 |
| Irgacure 819 | 1.09 | 1.09 | 1.09 | 1.09 | 1.09 |
| Irgacure 907 | 1.92 | 1.92 | | 1.92 | 1.92 |
| Darocur 1173 | 2.50 | | 2.50 | 1.25 | |
| Chivacure BMS | | 1.25 | | | |
| Chivacure 2-ITX | | 1.25 | | | |
| BHT | 0.48 | 0.48 | 0.48 | 0.48 | 0.48 |
| Ebecryl 350 | 5.00 | 5.00 | 5.00 | 5.00 | 5.00 |
| Total | 100.00 | 100.00 | 100.00 | 100.00 | 100.00 |

TABLE 32
Example 45 Colored Secondary Coating Modified to be LED curable

| | Example | Example | Example | Example | Example |
|---|---|---|---|---|---|
| | 45A | 45B | 45C | 45D | 45E |
| Components | wt. % | wt. % | wt. % | wt. % | wt. % |
| DG-0022 PPG/TDI/HEA | 23.50 | 13.50 | 23.50 | 2.00 | 23.50 |
| CN971A80 | | 15.00 | | 23.50 | |
| CN120Z | 42.00 | 37.00 | 42.00 | 42.00 | 42.00 |
| Pentaerythritol triacrylate | | | 7.00 | | |
| Trimethylpropane triacrylate | | | 3.11 | | |
| Tripropylene glycol diacrylate | 14.50 | 14.50 | 10.72 | 14.50 | 14.50 |
| Hexanediol diacrylate | 9.44 | 9.44 | 3.11 | 7.00 | 9.44 |
| Ethoxylated nonylphenol acrylate | 0.49 | 0.49 | 0.49 | 1.00 | 0.49 |
| White pigment dispersion | 0.80 | 0.80 | 0.80 | 0.80 | 0.80 |
| Orange pigment dispersion | 1.80 | 1.80 | 1.80 | 1.80 | 1.80 |
| Lucirin TPO-L | 2.00 | 2.00 | 1.00 | 2.00 | 1.00 |
| Irgacure 819 | 1.00 | 1.00 | 1.00 | 0.93 | 0.75 |
| Irgacure 907 | 0.50 | 0.50 | 0.50 | 0.50 | 0.50 |
| Esacure KIP100F | 2.00 | 1.00 | 1.00 | 1.00 | 0.75 |
| Darocur 1173 | | 1.00 | 2.00 | | 0.50 |
| Chivacure BMS | 0.50 | 0.50 | 0.50 | 0.50 | 0.50 |
| Chivacure 2-ITX | | | | 1.00 | 2.00 |
| BHT | 0.49 | 0.49 | 0.49 | 0.49 | 0.49 |
| Ebecryl 350 | | | 0.33 | | |
| DC-190 | 0.66 | 0.66 | 0.33 | 0.66 | 0.66 |
| DC-57 | 0.32 | 0.32 | 0.32 | 0.32 | 0.32 |
| Total | 100.00 | 100.00 | 100.00 | 100.00 | 100.00 |

TABLE 33
Example 46 LED curable Matrix Coatings

| | Example 46 A | Example 46 B | Example 46 C | Example 46 D | Example 46 E |
|---|---|---|---|---|---|
| Components | wt. % | wt. % | wt. % | wt. % | wt. % |
| PTHF 650/TDI/HEA | 38.00 | 36.00 | 36.00 | 38.00 | 30.00 |
| CN120Z | 28.00 | 30.00 | 30.00 | 28.00 | 36.00 |
| Isobornyl acrylate | 9.48 | 9.48 | 10.00 | 9.48 | 6.50 |
| Phenoxyethyl acrylate | 12.00 | 12.00 | 10.00 | 12.00 | 10.00 |
| Hexanediol diacrylate | 6.50 | 6.50 | 7.98 | 6.50 | 11.48 |
| Lucirin TPO-L | 2.00 | 2.00 | 2.00 | 1.00 | 2.00 |
| Irgacure 819 | 1.00 | 1.00 | 1.00 | 1.25 | 1.00 |
| Esacure KIP100F | 1.00 | 1.00 | 1.00 | 1.50 | 1.00 |
| Irganox 245 | 0.50 | 0.50 | 0.50 | 0.75 | 0.50 |
| Tinuvin 292 | 0.50 | 0.50 | 0.50 | 0.50 | 0.50 |
| DC-190 | 0.66 | 0.66 | 0.66 | 0.66 | 0.66 |
| DC-57 | 0.36 | 0.36 | 0.36 | 0.36 | 0.36 |
| Total | 100.00 | 100.00 | 100.00 | 100.00 | 100.00 |

Percent Reacted Acrylate Unsaturation for the Primary Coating abbreviated as % RAU Primary Test Method:

Degree of cure on the Top Surface of a Primary Coating on an optical fiber or metal wire is determined by FTIR using a diamond ATR accessory. FTIR instrument parameters include; 100 co-added scans, 4 cm⁻¹ resolution, DTGS detector, a spectrum range of 4000-650 cm⁻¹, and an approximately 25% reduction in the default mirror velocity to improve signal-to-noise. Two spectra are required; one of the uncured liquid coating that corresponds to the coating on the fiber or wire and one of the Primary Coating on the fiber or wire.

The spectrum of the liquid coating is obtained after completely covering the diamond surface with the coating. The liquid should be the same batch that is used to coat the fiber or wire if possible, but the minimum requirement is that it must be the same formulation. The final format of the spectrum should be in absorbance.

A thin film of contact cement is smeared on the center area of a 1-inch square piece of 3-mil Mylar film. After the contact cement becomes tacky, a piece of the optical fiber or wire is placed in it. Place the sample under a low power optical microscope. The coatings on the fiber or wire are sliced through to the glass using a sharp scalpel. The coatings are then cut lengthwise down the top side of the fiber of wire for approximately 1 centimeter, making sure that the cut is clean and that the Secondary coating does not fold into the Primary Coating. Then the coatings are spread open onto the contact cement such that the Primary Coating next to the glass or wire is exposed as a flat film. The glass fiber or wire is broken away in the area where the Primary Coating is exposed.

The exposed Primary Coating on the Mylar film is mounted on the center of the diamond with the fiber or wire axis parallel to the direction of the infrared beam. Pressure should be put on the back of the sample to insure good contact with the crystal. The resulting spectrum should not contain any absorbances from the contact cement. If contact cement peaks are observed, a fresh sample should be prepared. It is important to run the spectrum immediately after sample preparation rather than preparing any multiple samples and running spectra when all the sample preparations are complete. The final format of the spectrum should be in absorbance.

For both the liquid and the cured coating, measure the peak area of both the acrylate double bond peak at 810 cm-1 and a reference peak in the 750-780 cm-1 region. Peak area is determined using the baseline technique where a baseline is chosen to be tangent to absorbance minima on either side of the peak. The area under the peak and above the baseline is then determined. The integration limits for the liquid and the cured sample are not identical but are similar, especially for the reference peak.

The ratio of the acrylate peak area to the reference peak area is determined for both the liquid and the cured sample. Degree of cure, expressed as percent reacted acrylate unsaturation (% RAU), is calculated from the equation below:

$$\% RAU = \frac{( {R}_{L} - {R}_{P} ) \times 100}{{R}_{L}}$$

Where R_{L} is the area ration of the liquid sample and R_{F} is the area ration of the cured primary.

Percent Reacted Acrylate Unsaturation for the Secondary Coating abbreviated as % RAU Secondary Test Method

The degree of cure of the secondary coating on an optical fiber is determined by FTIR using a diamond ATR accessory. FTIR instrument parameters include: 100 co-added scans, 4 cm⁻¹ resolution, DTGS detector, a spectrum range of 4000-650 cm⁻¹, and an approximately 25% reduction in the default mirror velocity to improve signal-to-noise. Two spectra are required: one of the uncured liquid coating, that corresponds to the coating on the fiber and one of the outer coating on the fiber. The spectrum of the liquid coating is obtained after completely covering the diamond surface with the coating. The liquid should be the same batch that is used to coat the fiber if possible, but the minimum requirement is that it must be the same formulation. The final format of the spectrum should be in absorbance.

The fiber is mounted on the diamond and sufficient pressure is put on the fiber to obtain a spectrum suitable for quantitative analysis. For maximum spectral intensity, the fiber should be placed on the center of the diamond parallel to the direction of the infrared beam. If insufficient intensity is obtained with a single fiber, 2-3 fibers may be placed on the diamond parallel to each other and as close as possible. The final format of the spectrum should be in absorbance.

For both the liquid and the cured coating, measure the peak area of both the acrylate double bond peak at 810 cm⁻¹ and a reference peak in the 750-780 cm⁻¹ region. Peak area is determined using the baseline technique where a baseline is chosen to be tangent to absorbance minima on either side of the peak. The area under the peak and above the baseline is then determined. The integration limits for the liquid and the cured sample are not identical but are similar, especially for the reference peak.

The ratio of the acrylate peak area to the reference peak area is determined for both the liquid and the cured sample. Degree of cure, expressed as percent reacted acrylate unsaturation (% RAU), is calculated from the equation below:

$$\% RAU = \frac{( {R}_{L} - {R}_{P} ) \times 100}{{R}_{L}}$$

where R_{L} is the area ration of the liquid sample and R_{F} is the area ratio of the cured secondary coating.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1-15. (canceled)

16. A process for coating an optical fiber comprising:
(a) providing a glass optical fiber,
(b) coating said glass optical fiber with at least one radiation curable coating composition for an optical fiber, preferably a radiation curable coating composition which is capable of undergoing photopolymerization when coated on an optical fiber and when irradiated by a light emitting diode (LED) light, having a wavelength from 100 nm to 900 nm, to provide a cured coating on the optical fiber, said cured coating having a top surface, said cured coating having a Percent Reacted Acrylate Unsaturation (% RAU) at the top surface of 60% or greater,
wherein said at least one radiation curable coating composition comprises:
(i) at least one urethane (meth) acrylate oligomer;
(ii) at least one reactive diluent monomer; and
(iii) at least one photoinitiator;
to obtain a coated glass optical fiber with an uncured coating, and
(c) curing said uncured coating on said coated glass optical fiber by irradiating said uncured coating with a light emitting diode (LED) light, having a wavelength from 100 nm to 900 nm, to obtain a cured coating having a top surface, said cured coating having a % Reacted Acrylate Unsaturation (% RAU) at the top surface of about 60% or greater.

17. Process according to claim 16, wherein said glass optical fiber is provided by operating a glass draw tower to produce the glass optical fiber.

18. The process of claim 17, wherein the glass draw tower is operated at a line speed of the optical fiber from 100 m/min to 2500 m/min, such as from 1000 m/min to 2400 m/min, or from 1200 m/min to 2300 m/min.

19. The process of claim 16, wherein the light emitting diode (LED) light has a wavelength of
from 100 nm to 300 nm;
from 300 nm to 475 nm; or
from 475 nm to 900 nm.

20. The process of claim 16, wherein the photoinitiator is a Type I photoinitiator.

21. The process of claim 16, wherein the photoinitiator is a Type II photoinitiator and the composition includes a hydrogen donor.

22. A coated optical fiber is obtainable by the process of claim 16.

23. The coated optical fiber of claim 22, wherein the coating composition is selected from the group consisting of a primary coating composition, a secondary coating composition, an ink coating composition, a buffer coating composition, a matrix coating composition, and an Upjacketing coating composition.
